(19) United States
(12) Patent Application Publication
(10) Pub. No.: US 2006/0271675 A1
(43) Pub. Date: Nov. 30, 2006

(54) Image Reading System, Control Program of Image Reading Device, Control Program of Terminal Device, and Image Reading Device

(75) Inventors: Tomomi Wakazono, Nagoya-shi, Aichi-ken (JP); Sunao Kawai, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/421,033

(22) Filed: May 30, 2006

(30) Foreign Application Priority Data
May 31, 2005 (JP) 2005160646

(51) Int. Cl. G06F 15/173

(52) U.S. Cl. 709/224

(57) ABSTRACT

An image reading system comprises: a network; a plurality of image reading devices each of which is connected to the network and includes an image reading unit which reads an image and an image data transmitting unit which transmits image data obtained by the image reading unit to a terminal device on the network; and at least one terminal device which is connected to the network and includes an image data receiving unit which receives the image data transmitted by the image data transmitting unit. The terminal device includes a first notification broadcasting unit which broadcasts a notification (containing characteristic information capable of identifying the terminal device on the network) to the image reading devices on the network. The image data transmitting unit of an image reading device reading an image transmits the image data to the terminal device corresponding to the characteristic information contained in the notification received from the first notification broadcasting unit.

### CROSS-REFERENCE TO RELATED APPLICATION

This application claims priority under 35 U.S.C. §119 from Japanese Patent Application No. 2005-160646, filed on May 31, 2005. The entire subject matter of the application is incorporated herein by reference.

### FIELD

Aspects of the present invention relate to an image reading system in which an image of a document read by an image reading device such as a scanner is received by a terminal device such as a personal computer via a network, the image reading device in the image reading system, a control program of the image reading device, and a control program of the terminal device in the image reading system.

### BACKGROUND

Network scanning systems (hereinafter referred to as “image reading systems”), in which an image of a document read by an image reading device (e.g. scanner) is received by a terminal device (e.g. personal computer) via a network (e.g. LAN (Local Area Network)), are becoming widespread in recent years. Image reading devices used for such image reading systems are roughly classified into two types as described in Japanese Patent Provisional Publication No. P2002-111853A.

In an image reading device (scanner) of the first type, an instruction for starting the reading of a document image is received by an operation panel, a terminal device as the destination of image data (obtained by the image reading) is specified on the operation panel, and the image data as the result of image reading is sent out to the specified terminal device. In the following description, an image reading method employing an image reading device of the first type will be called a “push scan method”.

Meanwhile, in an image reading device (scanner) of the second type, the image reading is started in response to a document reading instruction which is sent from a terminal device as the destination of the image data, and the image data obtained by the image reading is transmitted to the terminal device. In the following description, an image reading method employing an image reading device of the second type will be called a “pull scan method”.

However, in order to use the pull scan method in a conventional image reading system, an IP address (for identifying the location of an image reading device on a network) has to be registered in each terminal device in regard to each image reading device on the network. Also when the push scan method is used, the IP address of an image reading device (to communicate with a terminal device) has to be registered in the terminal device while also registering the IP address of the terminal device in the image reading device.

Such registration of IP addresses is a complicated and troublesome task, placing a heavy load on an installer (user) in the installation of each image reading device or terminal device in an image reading system.

Further, in the case of the push scan method, if the terminal device as the destination of the image data is selected erroneously in the transmission of the image data from the image reading device, the image data is directly transmitted to the erroneously selected terminal device. Such misdelivery of image data (document) can lead to a leak of classified information.

### SUMMARY

Aspects of the present invention are advantageous in that an image reading system, a control program of an image reading device, a control program of a terminal device, and an image reading device, realizing the transmission of image data (of a document image read by an image reading device) to an intended terminal device without the need of the complicated IP address setting task, can be provided.

### BRIEF DESCRIPTION OF THE ACCOMPANYING DRAWINGS

FIG. 1 is a block diagram showing the composition of an image reading system in accordance with a first embodiment of the present invention.

FIG. 2A is a schematic diagram showing an example of memory structure of target PC memory of a scanner in the image reading system.

FIG. 2B is a schematic diagram showing an example of memory structure of registered PC memory of the scanner.

FIG. 3 is a conceptual diagram showing the flow of a push scan which is executed in the image reading system of the first embodiment.

FIG. 4A is a schematic diagram showing an option setting screen.

FIG. 4B is a schematic diagram showing a preview screen.

FIG. 5 is a flow chart showing a (PC side) push scan process according to the first embodiment.

FIG. 6 is a flow chart showing a scan process included in the (PC side) push scan process of the first embodiment.

FIG. 7 is a flow chart showing a (scanner side) push scan process according to the first embodiment.

FIG. 8 is a flow chart showing a target PC searching process included in the (scanner side) push scan process.

FIG. 9 is a flow chart showing a registered push scan process.

FIG. 10 is a conceptual diagram showing the flow of a push scan which is executed in an image reading system in accordance with a second embodiment of the present invention.

FIG. 11 is a flow chart showing a (PC side) push scan process according to the second embodiment.

FIG. 12 is a flow chart showing a scan process included in the (PC side) push scan process of the second embodiment.

FIG. 13 is a flow chart showing a target PC searching process according to the second embodiment.

FIG. 14 is a schematic diagram showing an example of memory structure of scanner memory of a PC in an image reading system in accordance with a third embodiment of the present invention.

FIG. 15 is a conceptual diagram showing the flow of a pull scan which is executed in the image reading system of the third embodiment.

FIG. 16 is a flow chart showing a (PC side) pull scan process according to the third embodiment.

FIG. 17 is a flow chart showing a scan process included in the (PC side) pull scan process of the third embodiment.

FIG. 18 is a flow chart showing a (scanner side) pull scan process according to the third embodiment.

FIG. 19 is a flow chart showing an image reading process according to the third embodiment.

FIG. 20 is a conceptual diagram showing the flow of a pull scan which is executed in an image reading system in accordance with a fourth embodiment of the present invention.

FIG. 21 is a flow chart showing a scan process according to the fourth embodiment.

FIG. 22 is a flow chart showing a (scanner side) pull scan process according to the fourth embodiment.

### DETAILED DESCRIPTION

General Overview

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

In accordance with an aspect of the present invention, there is provided an image reading system comprising: a network; a plurality of image reading devices each of which is connected to the network and includes an image reading unit which reads an image and an image data transmitting unit which transmits image data obtained by the image reading unit to a terminal device connected to the network; and at least one terminal device which is connected to the network and includes an image data receiving unit which receives the image data transmitted by the image data transmitting unit of the image reading device. The terminal device includes a first notification broadcasting unit which broadcasts a notification containing characteristic information capable of identifying the terminal device on the network to the plurality of image reading devices connected to the network. The image data transmitting unit of one of the plurality of image reading devices reading an image transmits the image data obtained by the image reading unit to the terminal device corresponding to the characteristic information contained in the notification received from the first notification broadcasting unit.

In the image reading system configured as above, the notification containing characteristic information capable of identifying a terminal device on the network is broadcasted (transmitted to a plurality of devices on the network in a lump) by the first notification broadcasting unit of the terminal device to the plurality of image reading devices connected to the network. The method of the “broadcast” is not particularly limited as long as data (notification, etc.) can be transmitted to a plurality of devices on the network in a lump. Meanwhile, the image data transmitting unit of one of the plurality of image reading devices reading an image transmits the image data obtained by the image reading unit to the terminal device corresponding to the characteristic information contained in the notification received from the first notification broadcasting unit. Consequently, the image data obtained by the image reading unit of the image reading device is received by the image data receiving unit of the terminal device.

Therefore, the plurality of image reading devices connected to the network can identify and recognize a terminal device on the network by receiving the characteristic information (IP address, node name, etc. capable of identifying the terminal device on the network) broadcasted by the terminal device. Consequently, the terminal device becomes capable of receiving image data read by each image reading device via the network without requiring the user to make complicated settings such as previously registering the characteristic information (IP address, node name, etc.) of the terminal device in each image reading device.

Further, since any image reading device on the network can be used freely for reading a document image, the inconvenience of specifying one particular image reading device for each document image reading can be eliminated.

An image reading device receiving the characteristic information (IP address, node name, etc.) from a terminal device is associated with the terminal device in a one-to-one correspondence, by which misdelivery of image data read by the image reading device to a different terminal device on the network can be prevented.

Preferably, the image reading device further includes an operation unit which is operated by a user for issuing an image reading instruction to the image reading unit. The image data transmitting unit transmits the image data to the terminal device corresponding to the characteristic information contained in the notification received from the first notification broadcasting unit when the image reading instruction is issued through the operation unit.

In the image reading system configured as above, when the image reading instruction is issued to the image reading unit through the operation unit, the image data is transmitted by the image data transmitting unit to the terminal device corresponding to the characteristic information contained in the notification received from the first notification broadcasting unit.

Therefore, an image reading system according to the push scan method, in which image data read by an image reading device is sent out to a terminal device in response to an operation to the operation unit of the image reading device, can be realized. Employing the push scan method for the image reading system is advantageous in that the user of the system can complete the document image reading and the transmission of the image data (obtained by the image reading) to the terminal device without the need of leaving the document set on the image reading device for the image reading, by which various problems caused by leaving the document unattended (loss of the document, theft, illicit viewing and replacement of the document by an outsider, etc.) can be reduced securely and that is advantageous from the viewpoint of security protection.

Preferably, the notification broadcasted by the first notification broadcasting unit of the terminal device further contains set values, to be used for the image reading by the image reading unit, in addition to the characteristic information. The image reading device receiving the notification from the first notification broadcasting unit lets the image reading unit read an image according to the set values contained in the received notification and lets the image data transmitting unit transmit image data obtained by the image reading unit to the terminal device corresponding to the characteristic information contained in the received notification.

In the image reading system configured as above, the set values to be used for the image reading by the image reading unit is broadcasted by the first notification broadcasting unit of the terminal device together with the characteristic information capable of identifying the terminal device on the network. In the image reading device receiving the notification from the first notification broadcasting unit, the image reading unit reads an image according to the set values contained in the received notification. Image data obtained by the image reading is transmitted by the image data transmitting unit to the terminal device corresponding to the characteristic information contained in the received notification.

Therefore, the set values for image reading which have been set on the terminal device side are automatically used by the image reading device for the image reading, by which the user is relieved of the need of setting the image reading set values again on the image reading device side. Thanks to the elimination of the need of setting the image reading set values again on the image reading device side, the user operation to the image reading device is simplified. Further, operation keys, display unit, etc. of the image reading device for making the image reading settings can be left out, by which the costs of the image reading device can be reduced.

Preferably, the image reading device further includes an image reading device-side display unit capable of displaying information. The notification broadcasted by the first notification broadcasting unit of the terminal device further contains terminal device identification information, to be used for displaying the terminal device on the image reading device-side display unit while characterizing the terminal device to be discriminable from other terminal devices, in addition to the characteristic information. The image reading device-side display unit of the image reading device displays the terminal device thereon while characterizing the terminal device to be discriminable from other terminal devices based on the terminal device identification information contained in the notification received from the first notification broadcasting unit.

In the image reading system configured as above, the terminal device identification information (to be used for displaying the terminal device on the image reading device-side L display unit of the image reading device while characterizing the terminal device to be discriminable from other terminal devices) is broadcasted by the first notification broadcasting unit of the terminal device together with the characteristic information capable of identifying the terminal device on the network. In the image reading device receiving the notification from the first notification broadcasting unit, the image reading device-side display unit displays the terminal device thereon while characterizing the terminal device to be discriminable from other terminal devices based on the terminal device identification information contained in the received notification.

Therefore, even when there are two or more terminal devices associated with the image reading device in a one-to-one correspondence, each terminal device is displayed on the image reading device-side display unit while being characterized based on the terminal device identification information to be discriminable from other terminal devices. For example, even when scan requests (image reading requests) from two or more terminal devices are received by the image reading device at the same time, the user of the image reading device can select a terminal device that is desired to be the destination of the image data without fail, by which misdelivery of the image data read by the image reading device can be prevented securely.

Preferably, the notification broadcasted by the first notification broadcasting unit of the terminal device further contains an authentication key associated with the terminal device in addition to the characteristic information. The image reading device further includes: an authentication key requesting unit which requests a user to input an authentication key; and an image reading prohibiting unit which prohibits the image reading by the image reading unit when the authentication key inputted by the user in response to the request by the authentication key requesting unit differs from the authentication key contained in the notification received from the first notification broadcasting unit.

In the image reading system configured as above, the authentication key associated with the terminal device is broadcasted by the first notification broadcasting unit of the terminal device together with the characteristic information capable of identifying the terminal device on the network. In the image reading device receiving the notification from the first notification broadcasting unit, the authentication key requesting unit requests the user to input an authentication key. When the authentication key inputted by the user in response to the request by the authentication key requesting unit differs from the authentication key contained in the notification received from the first notification broadcasting unit, the image reading by the image reading unit is prohibited by the image reading prohibiting unit.

Therefore, when an authentication key different from the authentication key associated with the terminal device is inputted by the user of the image reading device, the image reading by the image reading unit is prohibited and consequently, no image data is transmitted from the image reading device to the terminal device. As above, the user is not allowed to transmit image data to a terminal device that has been associated with an authentication key unknown to the user, by which misdelivery of image data to an unintended terminal device can be prevented. Further, transmission of image data to an unintended terminal device by an outsider and a resultant leak of the contents of the document can be eliminated.

Preferably, the image reading device further includes a second reply transmitting unit which replies to the notification from the first notification broadcasting unit by transmitting a reply containing characteristic information capable of identifying the image reading device on the network to the terminal device corresponding to the characteristic information contained in the received notification. The terminal device further includes an image reading request transmitting unit which transmits an image reading request to the image reading device corresponding to the characteristic information contained in the reply received from the second reply transmitting unit. The image reading device receiving the image reading request from the image reading request transmitting unit lets the image reading unit read an image and lets the image data transmitting unit transmit image data obtained by the image reading unit to the terminal device corresponding to the characteristic information contained in the notification received from the first notification broadcasting unit.

In the image reading system configured as above, when the notification from the first notification broadcasting unit is received by an image reading device, the second reply transmitting unit of the image reading device replies to the notification by transmitting a reply containing characteristic information (capable of identifying the image reading device on the network) to the terminal device corresponding to the characteristic information contained in the received notification. In the terminal device receiving the reply from the second reply transmitting unit, the image reading request transmitting unit transmits an image reading request to the image reading device corresponding to the characteristic information contained in the received reply. In the image reading device receiving the image reading request from the image reading request transmitting unit, the image reading unit reads an image and the image data transmitting unit transmits image data obtained by the image reading unit to the terminal device corresponding to the characteristic information contained in the notification received from the first notification broadcasting unit.

Therefore, an image reading system according to the pull scan method, in which image data read by an image reading device is transmitted to a terminal device in response to an image reading request from the terminal device, can be realized. Employing the pull scan method for the image reading system is advantageous in that the structure of the operation panel of the image reading device can be simplified by leaving out operation keys, display unit, etc. for inputting an instruction for starting the image reading operation and specifying the destination of the image data, by which the costs of the image reading device can be reduced.

Incidentally, the transmission of the image reading request to the image reading device by the “image reading request transmitting unit” of the terminal device may either be executed automatically upon reception of the reply from the second reply transmitting unit or in response to a user operation to the terminal device after the reception of the reply from the second reply transmitting unit.

Preferably, the terminal device further includes a terminal device-side display unit capable of displaying information. The reply transmitted by the second reply transmitting unit of the image reading device further contains image reading device identification information, to be used for displaying the image reading device on the terminal device-side display unit while characterizing the image reading device to be discriminable from other image reading devices, in addition to the characteristic information. The terminal device-side display unit of the terminal device displays the image reading device thereon while characterizing the image reading device to be discriminable from other image reading devices based on the image reading device identification information contained in the reply received from the second reply transmitting unit.

In the image reading system configured as above, the image reading device identification information (to be used for displaying the image reading device on the terminal device-side display unit while characterizing the image reading device to be discriminable from other image reading devices) is transmitted by the second reply transmitting unit of the image reading device together with the characteristic information capable of identifying the image reading device on the network. In the terminal device receiving the reply from the second reply transmitting unit, the terminal device-side display unit displays the image reading device thereon while characterizing the image reading device to be discriminable from other image reading devices based on the image reading device identification information contained in the received reply.

Therefore, even when there are two or more image reading devices associated with the terminal device in a one-to-one correspondence, each image reading device is displayed on the terminal device-side display unit while being characterized based on the terminal device identification information to be discriminable from other image reading devices. Consequently, the user of the terminal device can select an image reading device that is desired to be the reader of image data without fail, by which misdelivery of image data from an unintended image reading device can be prevented securely.

Preferably, the reply transmitted by the second reply transmitting unit of the image reading device further contains an authentication key associated with the image reading device in addition to the characteristic information. The terminal device further includes: an authentication key requesting unit which requests a user to input an authentication key; and an image reading request prohibiting unit which prohibits the transmission of the image reading request by the image reading request transmitting unit to the image reading device associated with the authentication key when the authentication key inputted by the user in response to the request by the authentication key requesting unit differs from the authentication key contained in the reply received from the second reply transmitting unit.

In the image reading system configured as above, the authentication key associated with the image reading device is transmitted by the second reply transmitting unit of the image reading device together with the characteristic information capable of identifying the image reading device on the network. In the terminal device receiving the reply from the second reply transmitting unit, the authentication key requesting unit requests the user to input an authentication key. When the authentication key inputted by the user in response to the request by the authentication key requesting unit differs from the authentication key contained in the reply received from the second reply transmitting unit, the transmission of the image reading request by the image reading request transmitting unit to the image reading device associated with the authentication key is prohibited by the image reading request prohibiting unit.

Therefore, when an authentication key different from the authentication key associated with the image reading device is inputted by the user of the terminal device, the issuance of the image reading request to the image reading device is prohibited and consequently, no image data is transmitted from the image reading device to the terminal device. As above, the user is not allowed to issue the image reading request to an image reading device that has been associated with an authentication key unknown to the user, by which misdelivery (erroneous reception) of image data from an unintended image reading device can be prevented. Further, theft of image data from an image reading device by an outsider can also be prevented.

Preferably, the image reading device further includes a terminal device registering unit which registers the characteristic information corresponding to the terminal device to which the image data has been transmitted by the image data transmitting unit.

In the image reading system configured as above, the characteristic information corresponding to the terminal device to which the image data has been transmitted by the image data transmitting unit is registered by the terminal device registering unit of the image reading device.

Therefore, characteristic information corresponding to each terminal device to which image data has been transmitted (IP address, node name, etc.) is automatically registered in the image reading device, by which the registered terminal devices become available as destinations of image data in the image reading system, without the need of the complicated and troublesome task of registration.

In accordance with another aspect of the present invention, there is provided an image reading system comprising: a network; at least one image reading device which is connected to the network and includes an image reading unit which reads an image and an image data transmitting unit which transmits image data obtained by the image reading unit to a terminal device connected to the network; and a plurality of terminal devices each of which is connected to the network and includes an image data receiving unit which receives the image data transmitted by the image data transmitting unit of the image reading device. The image reading device includes a second notification broadcasting unit which broadcasts a notification containing characteristic information capable of identifying the image reading device on the network to the plurality of terminal devices connected to the network. The terminal device includes a first reply transmitting unit which replies to the notification from the second notification broadcasting unit by transmitting a reply containing characteristic information capable of identifying the terminal device on the network to the image reading device corresponding to the characteristic information contained in the received notification. The image data transmitting unit of the image reading device receiving the reply from the first reply transmitting unit transmits the image data obtained by the image reading unit to one of the terminal devices corresponding to the characteristic information contained in the received reply.

In the image reading system configured as above, the notification containing characteristic information capable of identifying an image reading device on the network is broadcasted by the second notification broadcasting unit of the image reading device to the plurality of terminal devices connected to the network. In a terminal device receiving the notification from the second notification broadcasting unit, the first reply transmitting unit replies to the notification by transmitting a reply containing characteristic information capable of identifying the terminal device on the network to the image reading device corresponding to the characteristic information contained in the received notification. The image data transmitting unit of the image reading device receiving the reply from the first reply transmitting unit transmits the image data obtained by the image reading unit to one of the terminal devices corresponding to the characteristic information contained in the received reply.

Therefore, the plurality of terminal devices connected to the network can identify and recognize an image reading device on the network by receiving the characteristic information (IP address, node name, etc. capable of identifying the image reading device on the network) broadcasted by the image reading device. Meanwhile, a terminal device receiving the characteristic information broadcasted by the image reading device as above sends its own characteristic information (IP address, node name, etc.) to the image reading device (sender of the broadcasted characteristic information), by which the image reading device can also identify and recognize the terminal device on the network.

Consequently, each terminal device can receive image data read by the image reading device via the network without requiring the user to make complicated settings such as registering the characteristic information (IP address, node name, etc.) of each terminal device in the image reading device or registering the characteristic information (IP address, node name, etc.) of the image reading device in each terminal device.

Further, since any terminal device on the network can be used freely for receiving a document image, the inconvenience of specifying one particular terminal device for each document image reception can be eliminated.

Since an image reading device and a terminal device is associated with each other in a one-to-one correspondence, misdelivery of image data read by the image reading device to a different terminal device on the network can be prevented.

Preferably, the image reading device further includes an operation unit which is operated by a user for issuing an image reading instruction to the image reading unit. The image data transmitting unit transmits the image data to the terminal device corresponding to the characteristic information contained in the reply received from the first reply transmitting unit when the image reading instruction is issued through the operation unit.

In the image reading system configured as above, when the image reading instruction is issued to the image reading unit through the operation unit, the image data is transmitted by the image data transmitting unit to the terminal device corresponding to the characteristic information contained in the reply received from the first reply transmitting unit.

Therefore, an image reading system according to the push scan method, in which image data read by an image reading device is sent out to a terminal device in response to an operation to the operation unit of the image reading device, can be realized. Employing the push scan method for the image reading system is advantageous in that the user of the system can complete the document image reading and the transmission of the image data (obtained by the image reading) to the terminal device without the need of leaving the document set on the image reading device for the image reading, by which various problems caused by leaving the document unattended (loss of the document, theft, illicit viewing and replacement of the document by an outsider, etc.) can be reduced securely and that is advantageous from the viewpoint of security protection.

Preferably, the reply transmitted by the first reply transmitting unit of the terminal device further contains set values, to be used for the image reading by the image reading unit, in addition to the characteristic information. The image reading device receiving the reply from the first reply transmitting unit lets the image reading unit read an image according to the set values contained in the received reply and lets the image data transmitting unit transmit image data obtained by the image reading unit to the terminal device corresponding to the characteristic information contained in the received reply.

In the image reading system configured as above, the set values to be used for the image reading by the image reading unit is transmitted by the first reply transmitting unit of the terminal device together with the characteristic information capable of identifying the terminal device on the network. In the image reading device receiving the reply from the first reply transmitting unit, the image reading unit reads an image according to the set values contained in the received reply. Image data obtained by the image reading is transmitted by the image data transmitting unit to the terminal device corresponding to the characteristic information contained in the received reply.

Therefore, the set values for image reading which have been set on the terminal device side are automatically used by the image reading device for the image reading, by which the user is relieved of the need of setting the image reading set values again on the image reading device side. Thanks to the elimination of the need of setting the image reading set values again on the image reading device side, the user operation to the image reading device is simplified. Further, operation keys, display unit, etc. of the image reading device for making the image reading settings can be left out, by which the costs of the image reading device can be reduced.

Preferably, the image reading device further includes an image reading device-side display unit capable of displaying information. The reply transmitted by the first reply transmitting unit of the terminal device further contains terminal device identification information, to be used for displaying the terminal device on the image reading device-side display unit while characterizing the terminal device to be discriminable from other terminal devices, in addition to the characteristic information. The image reading device-side display unit of the image reading device displays the terminal device thereon while characterizing the terminal device to be discriminable from other terminal devices based on the terminal device identification information contained in the reply received from the first reply transmitting unit.

In the image reading system configured as above, the terminal device identification information (to be used for displaying the terminal device on the image reading device-side display unit of the image reading device while characterizing the terminal device to be discriminable from other terminal devices) is transmitted by the first reply transmitting unit of the terminal device together with the characteristic information capable of identifying the terminal device on the network. In the image reading device receiving the reply from the first reply transmitting unit, the image reading device-side display unit displays the terminal device thereon while characterizing the terminal device to be discriminable from other terminal devices based on the terminal device identification information contained in the received reply.

Therefore, even when there are two or more terminal devices associated with the image reading device in a one-to-one correspondence, each terminal device is displayed on the image reading device-side display unit while being characterized based on the terminal device identification information to be discriminable from other terminal devices. For example, even when scan requests (image reading requests) from two or more terminal devices are received by the image reading device at the same time, the user of the image reading device can select a terminal device that is desired to be the destination of the image data without fail, by which misdelivery of the image data read by the image reading device can be prevented securely.

Preferably, the reply transmitted by the first reply transmitting unit of the terminal device further contains an authentication key associated with the terminal device in addition to the characteristic information. The image reading device further includes: an authentication key requesting unit which requests a user to input an authentication key; and an image reading prohibiting unit which prohibits the image reading by the image reading unit when the authentication key inputted by the user in response to the request by the authentication key requesting unit differs from the authentication key contained in the reply received from the first reply transmitting unit.

In the image reading system configured as above, the authentication key associated with the terminal device is transmitted by the first reply transmitting unit of the terminal device together with the characteristic information capable of identifying the terminal device on the network. In the image reading device receiving the reply from the first reply transmitting unit, the authentication key requesting unit requests the user to input an authentication key. When the authentication key inputted by the user in response to the request by the authentication key requesting unit differs from the authentication key contained in the reply received from the first reply transmitting unit, the image reading by the image reading unit is prohibited by the image reading prohibiting unit.

Therefore, when an authentication key different from the authentication key associated with the terminal device is inputted by the user of the image reading device, the image reading by the image reading unit is prohibited and consequently, no image data is transmitted from the image reading device to the terminal device. As above, the user is not allowed to transmit image data to a terminal device that has been associated with an authentication key unknown to the user, by which misdelivery of image data to an unintended terminal device can be prevented. Further, transmission of image data to an unintended terminal device by an outsider and a resultant leak of the contents of the document can be eliminated.

Preferably, the terminal device further includes an image reading request transmitting unit which transmits an image reading request to the image reading device corresponding to the characteristic information contained in the notification received from the second notification broadcasting unit. The image reading device receiving the image reading request from the image reading request transmitting unit lets the image reading unit read an image and lets the image data transmitting unit transmit image data obtained by the image reading unit to the terminal device corresponding to the characteristic information contained in the reply received from the first reply transmitting unit.

In the image reading system configured as above, when the notification from the second notification broadcasting unit is received by a terminal device, the image reading request transmitting unit of the terminal device transmits the image reading request to the image reading device corresponding to the characteristic information contained in the received notification. In the image reading device receiving the image reading request from the image reading request transmitting unit, the image reading unit reads an image and the image data transmitting unit transmits image data obtained by the image reading unit to the terminal device corresponding to the characteristic information contained in the reply received from the first reply transmitting unit.

Therefore, an image reading system according to the pull scan method, in which image data read by an image reading device is transmitted to a terminal device in response to an image reading request from the terminal device, can be realized. Employing the pull scan method for the image reading system is advantageous in that the structure of the operation panel of the image reading device can be simplified by leaving out operation keys, display unit, etc. for inputting an instruction for starting the image reading operation and specifying the destination of the image data, by which the costs of the image reading device can be reduced.

Incidentally, the transmission of the image reading request to the image reading device by the “image reading request transmitting unit” of the terminal device may either be executed automatically upon reception of the notification from the second notification broadcasting unit or in response to a user operation to the terminal device after the reception of the notification from the second notification broadcasting unit.

Preferably, the terminal device further includes a terminal device-side display unit capable of displaying information. The notification broadcasted by the second notification broadcasting unit of the image reading device further contains image reading device identification information, to be used for displaying the image reading device on the terminal device-side display unit while characterizing the image reading device to be discriminable from other image reading devices, in addition to the characteristic information. The terminal device-side display unit of the terminal device displays the image reading device thereon while characterizing the image reading device to be discriminable from other image reading devices based on the image reading device identification information contained in the notification received from the second notification broadcasting unit.

In the image reading system configured as above, the image reading device identification information (to be used for displaying the image reading device on the terminal device-side display unit while characterizing the image reading device to be discriminable from other image reading devices) is broadcasted by the second notification broadcasting unit of the image reading device together with the characteristic information capable of identifying the image reading device on the network. In the terminal device receiving the notification from the second notification broadcasting unit, the terminal device-side display unit displays the image reading device thereon while characterizing the image reading device to be discriminable from other image reading devices based on the image reading device identification information contained in the received notification.

Therefore, even when there are two or more image reading devices associated with the terminal device in a one-to-one correspondence, each image reading device is displayed on the terminal device-side display unit while being characterized based on the terminal device identification information to be discriminable from other image reading devices. Consequently, the user of the terminal device can select an image reading device that is desired to be the reader of image data without fail, by which misdelivery of image data from an unintended image reading device can be prevented securely.

Preferably, the notification broadcasted by the second notification broadcasting unit of the image reading device further contains an authentication key associated with the image reading device in addition to the characteristic information. The terminal device further includes: an authentication key requesting unit which requests a user to input an authentication key; and an image reading request prohibiting unit which prohibits the transmission of the image reading request by the image reading request transmitting unit to the image reading device associated with the authentication key when the authentication key inputted by the user in response to the request by the authentication key requesting unit differs from the authentication key contained in the notification received from the second notification broadcasting unit.

In the image reading system configured as above, the authentication key associated with the image reading device is broadcasted by the second notification broadcasting unit of the image reading device together with the characteristic information capable of identifying the image reading device on the network. In the terminal device receiving the notification from the second notification broadcasting unit, the authentication key requesting unit requests the user to input an authentication key. When the authentication key inputted by the user in response to the request by the authentication key requesting unit differs from the authentication key contained in the notification received from the second notification broadcasting unit, the transmission of the image reading request by the image reading request transmitting unit to the image reading device associated with the authentication key is prohibited by the image reading request prohibiting unit.

Therefore, when an authentication key different from the authentication key associated with the image reading device is inputted by the user of the terminal device, the issuance of the image reading request to the image reading device is prohibited and consequently, no image data is transmitted from the image reading device to the terminal device. As above, the user is not allowed to issue the image reading request to an image reading device that has been associated with an authentication key unknown to the user, by which misdelivery (erroneous reception) of image data from an unintended image reading device can be prevented. Further, theft of image data from an image reading device by an outsider can also be prevented.

Preferably, the image reading device further includes a terminal device registering unit which registers the characteristic information corresponding to the terminal device to which the image data has been transmitted by the image data transmitting unit.

In the image reading system configured as above, the characteristic information corresponding to the terminal device to which the image data has been transmitted by the image data transmitting unit is registered by the terminal device registering unit of the image reading device.

Therefore, characteristic information corresponding to each terminal device to which image data has been transmitted (IP address, node name, etc.) is automatically registered in the image reading device, by which the registered terminal devices become available as destinations of image data in the image reading system, without the need of the complicated and troublesome task of registration.

Preferably, the terminal device further includes an image reading device registering unit which registers the characteristic information corresponding to the image reading device from which the image data has been received by the image data receiving unit.

In the image reading system configured as above, the characteristic information corresponding to the image reading device from which the image data has been received by the image data receiving unit is registered by the image reading device registering unit of the terminal device.

Therefore, characteristic information corresponding to each image reading device from which image data has been received (IP address, node name, etc.) is automatically registered in the terminal device, by which the registered image reading devices become available as readers (senders) of image data in the image reading system, without the need of the complicated and troublesome task of registration.

In accordance with another aspect of the present invention, there is provided a computer program product comprising computer-readable instructions to be executed by a computer, being capable of functioning as an image reading device connected to a network, the instructions causing the computer to: read an image; and to transmit image data obtained by the image reading to a terminal device corresponding to characteristic information contained in a notification when the notification, containing the characteristic information capable of identifying the terminal device on the network and having been broadcasted by the terminal device connected to the network, is received by the image reading device.

Preferably, the image reading device includes an operation unit which is operated by a user for issuing an image reading instruction. The image data is transmitted to the terminal device corresponding to the characteristic information contained in the received notification when the image reading instruction is issued through the operation unit.

Preferably, the image reading device includes a display unit capable of displaying information. The computer-readable instructions further cause the computer to display the terminal device on the display unit while characterizing the terminal device to be discriminable from other terminal devices based on terminal device identification information when the terminal device identification information, to be used for displaying the terminal device on the display unit while characterizing the terminal device to be discriminable from other terminal devices, is received from the terminal device together with the characteristic information capable of identifying the terminal device on the network.

Preferably, the computer-readable instructions further cause the computer to request a user to input an authentication key when an authentication key associated with the terminal device is received from the terminal device together with the characteristic information capable of identifying the terminal device on the network, and to prohibit the image reading when the authentication key inputted by the user in response to the request for the authentication key differs from the authentication key associated with the terminal device corresponding to the received characteristic information.

Preferably, the image reading is executed when an image reading request is received from the terminal device corresponding to the characteristic information contained in the received notification. The image data obtained by the image reading is transmitted to the terminal device that transmitted the image reading request.

In accordance with another aspect of the present invention, there is provided a computer program product comprising computer-readable instructions to be executed by a computer, being capable of functioning as an image reading device connected to a network. The instructions cause the computer to broadcast a notification containing characteristic information capable of identifying the image reading device on the network to a plurality of A terminal devices connected to the network, to read an image when a reply containing characteristic information capable of identifying a terminal device on the network is received from the terminal device that received the broadcasted notification, and to transmit image data of the read image to the terminal device corresponding to the characteristic information contained in the received reply.

Preferably, the image reading device includes an operation unit which is operated by a user for issuing an image reading instruction. The image data is transmitted to the terminal device corresponding to the characteristic information contained in the received reply when the image reading instruction is issued through the operation unit.

Preferably, the image reading device includes a display unit capable of displaying information. The computer-readable instructions further cause the computer to display the terminal device on the display unit while characterizing the terminal device to be discriminable from other terminal devices based on terminal device identification information when the terminal device identification information, to be used for displaying the terminal device on the display unit while characterizing the terminal device to be discriminable from other terminal devices, is received from the terminal device together with the characteristic information capable of identifying the terminal device on the network.

Preferably, the computer-readable instructions further cause the computer to request a user to input an authentication key when an authentication key associated with the terminal device is received from the terminal device together with the characteristic information capable of identifying the terminal device on the network, and to prohibit the image reading when the authentication key inputted by the user in response to the request of the authentication key differs from the authentication key associated with the terminal device corresponding to the received characteristic information.

Preferably, the image reading is executed when an image reading request is received from the terminal device corresponding to the characteristic information contained in the received reply. The obtained image data is transmitted to the terminal device that transmitted the image reading request.

In accordance with another aspect of the present invention, there is provided a computer program product comprising computer-readable instructions to be executed by a computer, being capable of functioning as a terminal device connected to a network. The instructions cause the computer to broadcast a notification containing characteristic information capable of identifying the terminal device on the network to a plurality of image reading devices connected to the network, and to receive image data, obtained by an image reading device by image reading, from the image reading device that received the broadcasted notification.

Preferably, the terminal device includes a display unit capable of displaying information. The computer-readable instructions further cause the computer to display an image reading device on the display unit while characterizing the image reading device to be discriminable from other image reading devices based on image reading device identification information when the image reading device identification information, to be used for displaying the image reading device on the display unit while characterizing the image reading device to be discriminable from other image reading devices, is received from the image reading device together with characteristic information capable of identifying the image reading device on the network.

Preferably, the computer-readable instructions further cause the computer to transmit an image reading request to an image reading device connected to the network, to request a user to input an authentication key when an authentication key associated with the image reading device is received from the image reading device together with characteristic information capable of identifying the image reading device on the network, and to prohibit the transmission of the image reading request to the image reading device associated with the authentication key when the authentication key inputted by the user in response to the request of the authentication key differs from the authentication key associated with the image reading device corresponding to the received characteristic information.

In accordance with another aspect of the present invention, there is provided a computer program product comprising computer-readable instructions to be executed by a computer, being capable of functioning as a terminal device connected to a network. The instructions cause the computer to transmit a reply containing characteristic information capable of identifying the terminal device on the network to an image reading device that sent a notification when the notification containing characteristic information capable of identifying an image reading device on the network is received from the image reading device connected to the network, and to receive image data, obtained by the image reading device by image reading, from the image reading device that received the reply.

Preferably, the terminal device includes a display unit capable of displaying information. The computer-readable instructions further cause the computer to display the image reading device on the display unit while characterizing the image reading device to be discriminable from other image reading devices based on image reading device identification information when the image reading device identification information, to be used for displaying the image reading device on the display unit while characterizing the image reading device to be discriminable from other image reading devices, is received from the image reading device together with the characteristic information capable of identifying the image reading device on the network.

Preferably, the computer-readable instructions further cause the computer to transmit an image reading request to the image reading device connected to the network, to request a user to input an authentication key when an authentication key associated with the image reading device is received from the image reading device together with the characteristic information capable of identifying the image reading device on the network, and to prohibit the transmission of the image reading request to the image reading device associated with the authentication key when the authentication key inputted by the user in response to the request of the authentication key differs from the authentication key associated with the image reading device corresponding to the received characteristic information.

By the computer program products configured as above, effects similar to those of the image reading systems explained above can be achieved.

In accordance with another aspect of the present invention, there is provided an image reading device connected to a network, comprising: an image reading unit which reads an image; and an image data transmitting unit which transmits image data obtained by the image reading unit to a terminal device corresponding to characteristic information contained in a notification when the notification, containing the characteristic information capable of identifying the terminal device on the network and having been broadcasted by the terminal device connected to the network, is received by the image reading device.

Preferably, the image reading device further comprises an operation unit which is operated by a user for issuing an image reading instruction. The image data transmitting unit transmits the image data to the terminal device corresponding to the characteristic information contained in the received notification when the image reading instruction is issued through the operation unit.

Preferably, the image reading device further comprises: a display unit capable of displaying information; and a display unit which displays the terminal device on the display unit while characterizing the terminal device to be discriminable from other terminal devices based on terminal device identification information when the terminal device identification information, to be used for displaying the terminal device on the display unit while characterizing the terminal device to be discriminable from other terminal devices, is received from the terminal device together with the characteristic information capable of identifying the terminal device on the network.

Preferably, the image reading device further comprises: an authentication key requesting unit which requests a user to input an authentication key when an authentication key associated with the terminal device is received from the terminal device together with the characteristic information capable of identifying the terminal device on the network; and an image reading prohibiting unit which prohibits the image reading by the image reading unit when the authentication key inputted by the user in response to the request by the authentication key requesting unit differs from the authentication key associated with the terminal device corresponding to the received characteristic information.

Preferably, the image reading unit executes the image reading when an image reading request is received from the terminal device corresponding to the characteristic information contained in the received notification. The image data transmitting unit transmits the image data obtained by the image reading unit to the terminal device that transmitted the image reading request.

In accordance with another aspect of the present invention, there is provided an image reading device connected to a network, comprising: a notification broadcasting unit which broadcasts a notification containing characteristic information capable of identifying the image reading device on the network to a plurality of terminal devices connected to the network; an image reading unit which reads an image when a reply containing characteristic information capable of identifying a terminal device on the network is received from the terminal device that received the notification broadcasted by the notification broadcasting unit; and an image data transmitting unit which transmits image data obtained by the image reading unit to the terminal device corresponding to the characteristic information contained in the received reply.

Preferably, the image reading device further comprises an operation unit which is operated by a user for issuing an image reading instruction. The image data transmitting unit transmits the image data to the terminal device corresponding to the characteristic information contained in the received reply when the image reading instruction is issued through the operation unit.

Preferably, the image reading device further comprises: a display unit capable of displaying information; and a display unit which displays the terminal device on the display unit while characterizing the terminal device to be discriminable from other terminal devices based on terminal device identification information when the terminal device identification information, to be used for displaying the terminal device on the display unit while characterizing the terminal device to be discriminable from other terminal devices, is received from the terminal device together with the characteristic information capable of identifying the terminal device on the network.

Preferably, the image reading device further comprises: an authentication key requesting unit which requests a user to input an authentication key when an authentication key associated with the terminal device is received from the terminal device together with the characteristic information capable of identifying the terminal device on the network; and an image reading prohibiting unit which prohibits the image reading by the image reading unit when the authentication key inputted by the user in response to the request by the authentication key requesting unit differs from the authentication key associated with the terminal device corresponding to the received characteristic information.

Preferably, the image reading unit executes the image reading when an image reading request is received from the terminal device corresponding to the characteristic information contained in the received reply. The image data transmitting unit transmits the image data obtained by the image reading unit to the terminal device that transmitted the image reading request.

By the image reading devices configured as above, effects similar to those of the image reading systems explained above can be achieved.

### Illustrative Embodiments

Referring now to the drawings, a description will be given in detail of illustrative embodiments in accordance with the present invention.

### First Embodiment

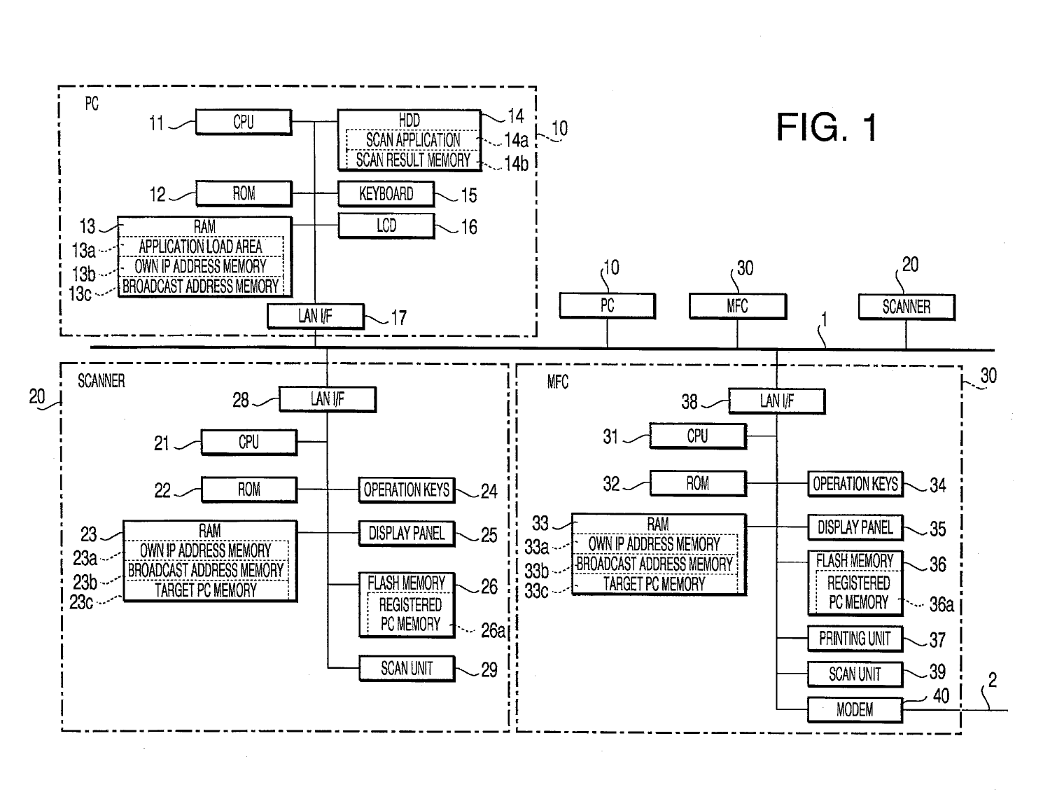

First, an image reading system in accordance with a first embodiment of the present invention will be described referring to FIGS. 1-9.

FIG. 1 is a block diagram showing the composition of the image reading system of the first embodiment. As shown in FIG. 1, the image reading system of the first embodiment includes a plurality of PCs (Personal Computers) 10 as terminal devices, a plurality of scanners 20 as image reading devices, and a plurality of MFPs (Multi Function Peripherals) 30 also as image reading devices. The PCs 10, scanners 20 and MFPs 30 are connected together by a LAN cable 1. Incidentally, the image reading system of this embodiment is a system according to the push scan method, in which image data of a document image read by a scanner 20 or MFP 30 is sent out to a PC 10 via the LAN cable 1 in response to a document image reading instruction issued by the PC 10 to the scanner 20 or MFP 30.

Each PC 10 includes a CPU (Central Processing Unit) 11, a ROM (Read Only Memory) 12, a RAM (Random Access Memory) 13, an HDD (Hard Disk Drive) 14, a keyboard 15, an LCD (Liquid Crystal Display) 16 and a LAN I/F (interface) 17. The CPU 11 as a computing unit executes programs stored in the ROM 12 and the RAM 13. The ROM 12 as a non-rewritable memory stores basic programs such as a boot program.

The RAM 13 as a rewritable memory includes an application load area 13a, own IP address memory 13b and broadcast address memory 13c. The application load area 13a is an area in which an application program stored in the HDD 14 is loaded temporarily. The own IP address memory 13b stores an IP address representing the location of the PC 10 itself on the LAN. The broadcast address memory 13c stores a broadcast address which has been assigned for the broadcast of data (simultaneous transmission of data to all the image reading devices and terminal devices belonging to a LAN).

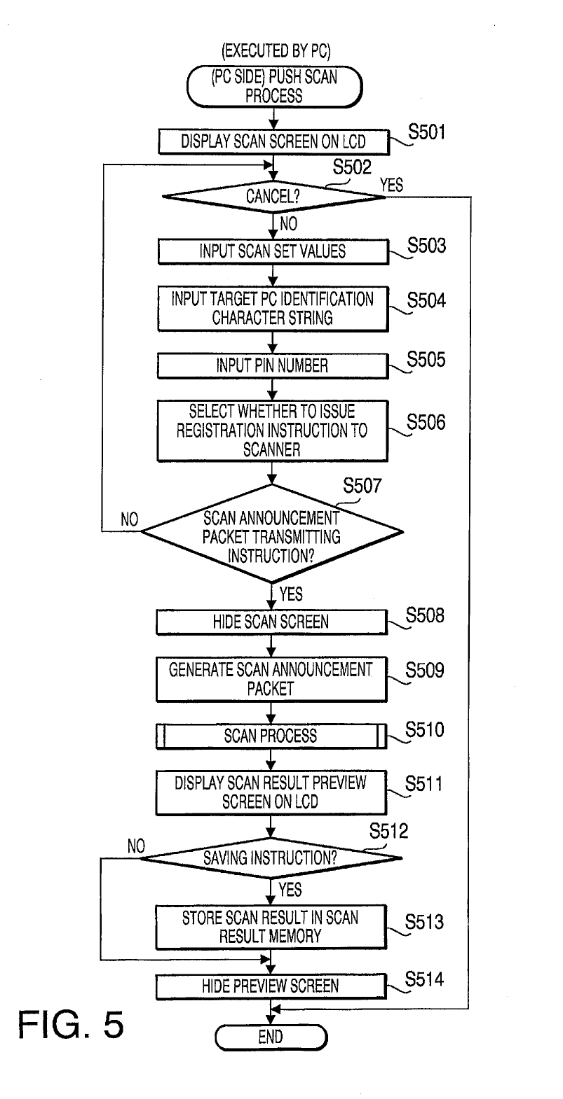

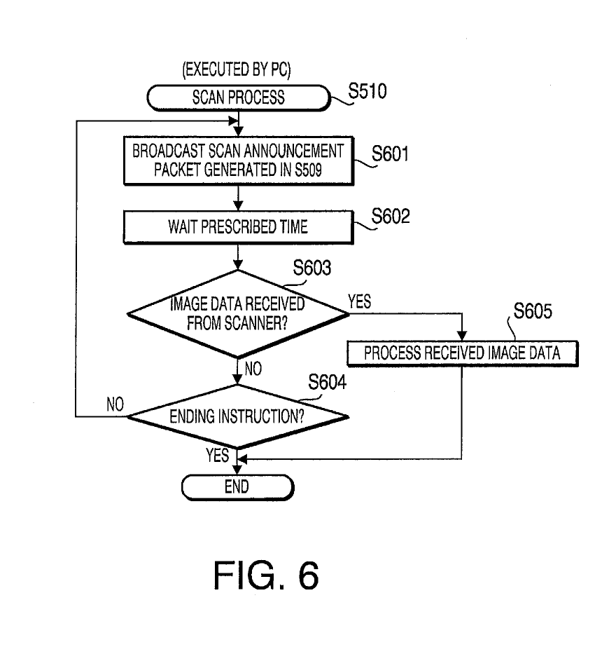

The HDD 14 as a rewritable memory stores an OS (Operating System) and various application programs executed by the PC 10. A scan application program 14a for a scan application for executing flow charts of FIGS. 5 and 6 (hereinafter also referred to simply as an “application”) is also stored in the HDD 14. The scan application program 14a is executed by the CPU 11 after being loaded from the HDD 14 to the application load area 13a of the RAM 13. The HDD 14 includes scan result memory 14b for storing image data received from the scanners 20 and MFPs 30.

The keyboard 15 is an input device for receiving user operations. The LCD 16 is a display device for displaying characters, figures, icons, etc. The LAN I/F 17 is an interface for communicating data, etc. with each device connected to the LAN cable 1.

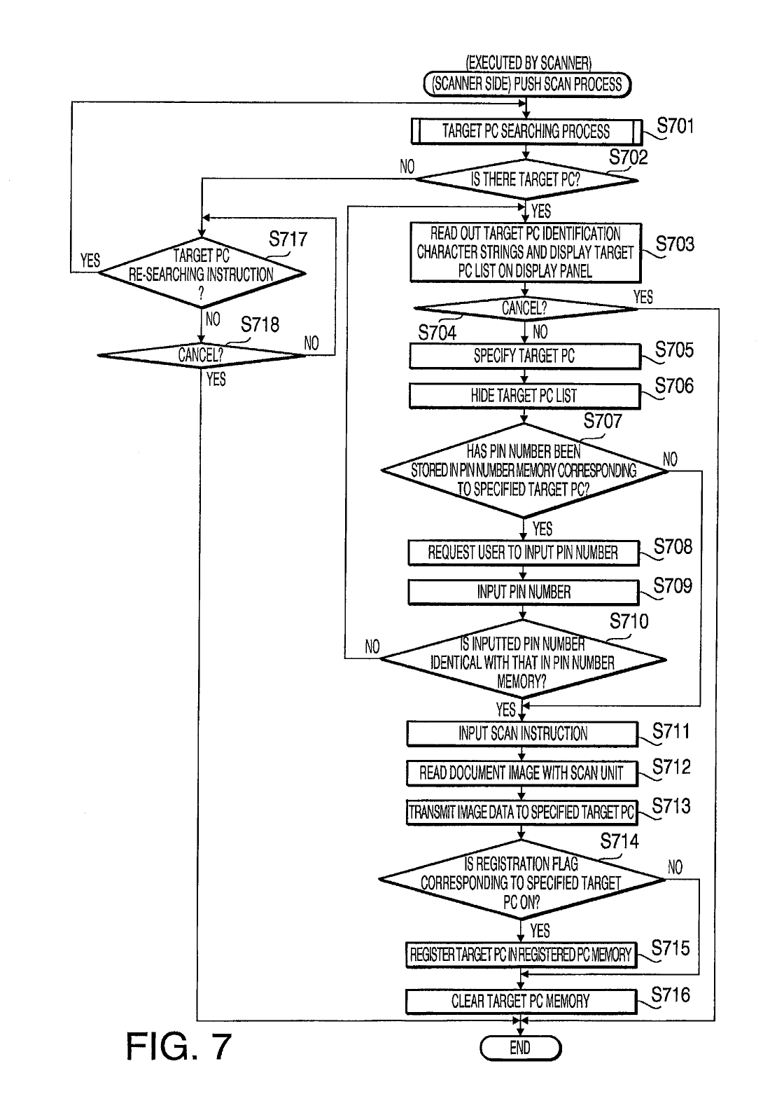

Each scanner 20 includes a CPU 21, a ROM 22, a RAM 23, operation keys 24, a display panel 25, a flash memory 26, a scan unit 29 and a LAN I/F 28. The CPU 21 as a computing unit executes programs stored in the ROM 22. The ROM 22 as a non-rewritable memory stores programs which are shown in flow charts of FIGS. 7-9.

The RAM 23 as a rewritable memory includes own IP address memory 23a, broadcast address memory 23b and target PC memory 23c. The own IP address memory 23a stores an IP address of the scanner 20 itself on the LAN. The broadcast address memory 23b stores a broadcast address which has been assigned for the broadcast (simultaneous transmission of data to all the image reading devices and terminal devices belonging to a LAN).

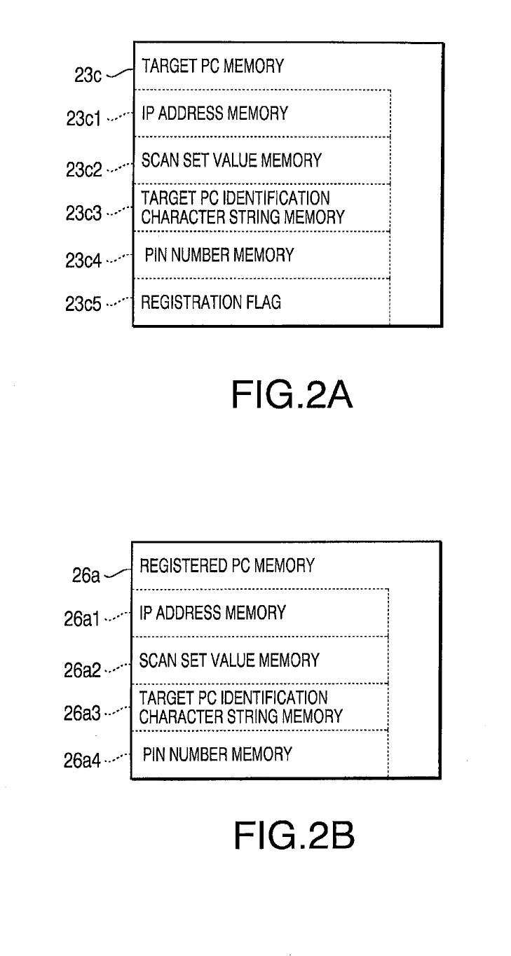

The target PC memory 23c stores information contained in a scan announcement packet when the scan announcement packet is received from a PC 10. Here, the target PC memory 23c will be explained more concretely referring to FIG. 2A. FIG. 2A is a schematic diagram showing an example of memory structure of the target PC memory 23c.

As shown in FIG. 2A, the target PC memory 23c includes IP address memory 23c1, scan set value memory 23c2, target PC identification character string memory 23c3, PIN number memory 23c4 and a registration flag 23c5.

The IP address memory 23c1 stores an IP address of each PC 10 as a destination of image data (hereinafter referred to as a “target PC”). The scan set value memory 23c2 stores settings (resolution, the number of colors, document size, etc., hereinafter referred to as “scan set values”) to be used by the scanner 20 for reading a document image.

The target PC identification character string memory 23c3 stores a character string (hereinafter referred to as a “target PC identification character string”) representing each PC 10 as a destination of image data (target PC). The character string will be displayed on the display panel 25 in a (scanner side) push scan process which will be explained later (see FIG. 7).

The PIN number memory 23c4 stores a character string as an authentication key of each PC 10 (hereinafter referred to as a “PIN number”). The registration flag 23c5 is a flag indicating whether or not a PC 10 as the sender of the scan announcement packet (i.e. a PC 10 whose information has already been stored in the target PC memory 23c) should be registered in the scanner 20 (registered PC memory 26a) as a destination of image data. The registration flag 23c5 is set OFF (initial state) when the (scanner side) push scan process which will be explained later (see FIG. 7) is started, and turned ON when a scan announcement packet received from the PC 10 contains a registration instruction to the scanner 20.

Incidentally, the target PC memory 23c (23c1-23c5) stores information on each PC 10 from which the scan announcement packet has been received. In other words, there exist as many target PC memories 23c (23c1-23c5) as the PCs 10 from which the scan announcement packet has been received.

The operation keys 24, as an input device, are used for operating the scanner 20. The display panel 25 is a display device for displaying characters, figures, icons, etc. The flash memory 26 is a rewritable nonvolatile memory. Data stored in the flash memory 26 is retained even when the power of the scanner 20 is turned OFF.

The flash memory 26 includes registered PC memory 26a. The registered PC memory 26a stores information on PCs 10 on the LAN that have been registered as destinations of image data. Here, the registered PC memory 26a will be explained more concretely referring to FIG. 2B. FIG. 2B is a schematic diagram showing an example of memory structure of the registered PC memory 26a.

As shown in FIG. 2B, the registered PC memory 26a includes IP address memory 26a1, scan set value memory 26a2, target PC identification character string memory 26a3 and PIN number memory 26a4.

In the registered PC memory 26a, information already stored in target PC memories 23c (corresponding to target PCs 10) that contain the registration flag 23c5 representing “ON” is stored in the (scanner side) push scan process which will be explained later (see FIG. 7). Therefore, the IP address memory 26a1 stores part or all of IP addresses that have been stored in the IP address memory 23c1, as IP addresses of target PCs that have been registered as destinations of image data. The scan set value memory 26a2 stores the scan set values which have been stored in the scan set value memory 23c2.

Similarly, the target PC identification character string memory 26a3 stores the target PC identification character strings which have been stored in the target PC identification character string memory 23c3, and the PIN number memory 26a4 stores the PIN numbers which have been stored in the PIN number memory 23c4.

Incidentally, the registered PC memory 26a (26a1-26a4) stores information on each PC 10 that has been registered in the scanner 20. In other words, there exist as many registered PC memories 26a (26a1-26a4) as the registered PCs 10.

The scan unit 29 is a unit for scanning a document and thereby reading a document image. The document image read by the scan unit 29 is stored in the RAM 23 or the flash memory 26 as digital data. The LAN I/F 28 is an interface for communicating data, etc. with each device connected to the LAN cable 1.

Each MFP 30, as a multi function peripheral device having not only the scanner function but also the facsimile function and printer function, includes a CPU 31, a ROM 32, a RAM 33, operation keys 34, a display panel 35, a flash memory 36, a printing unit 37, a LAN I/F 38, a scan unit 39 and a modem 40. Among the components, the CPU 31, ROM 32, RAM 33, operation keys 34, display panel 35, flash memory 36, scan unit 39 and LAN I/F 38 have functions equivalent to those of corresponding components of the scanner 20, and thus repeated explanation thereof is omitted here. The printing unit 37 is a unit for printing on a sheet (paper, etc.) and feeding the printed sheet. The modem 40 is a unit for modulating/demodulating image data and transmitting/receiving image data to/from other facsimile machines via a telephone line 2, while transmitting/receiving various procedural signals for transmission control.

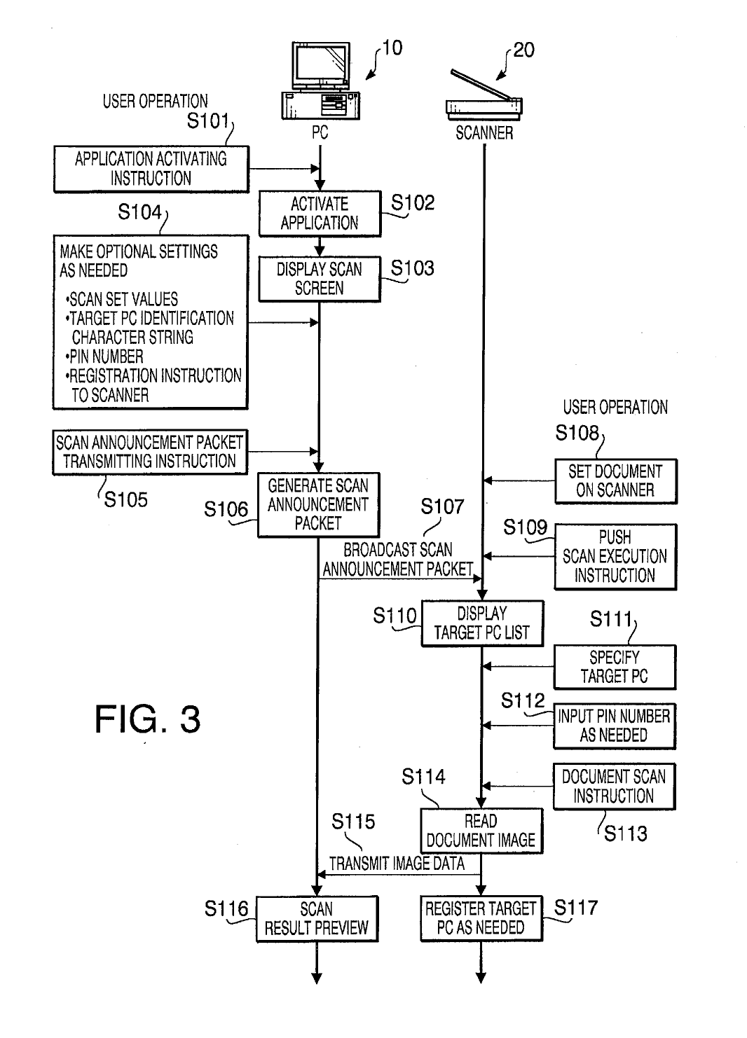

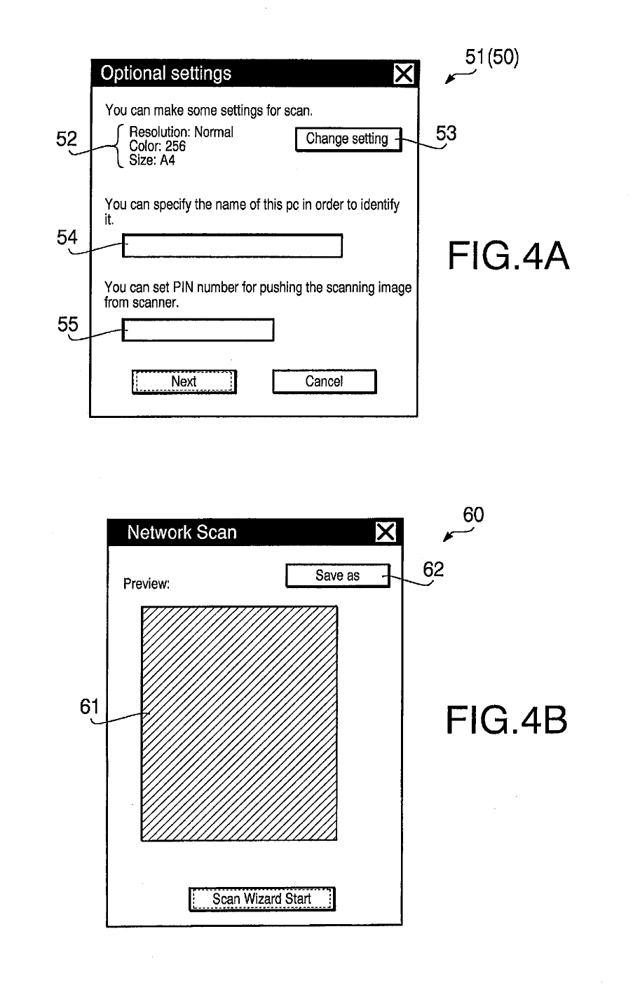

Next, the overall flow of a “push scan” which is executed in the image reading system of the first embodiment configured as above will be explained referring to FIGS. 3 and 4. Incidentally, the following explanation about the image reading system of the first embodiment will be given taking a push scan executed between a PC 10 and a scanner 20 as an example.

FIG. 3 is a conceptual diagram showing the flow of the push scan executed in the image reading system of the first embodiment. FIG. 4A is a schematic diagram showing an optional settings screen 51 as a part of a scan screen 50 which is displayed on the LCD 16 when the aforementioned “application” is activated on a PC 10. FIG. 4B is a schematic diagram showing a preview screen 60 which is displayed on the LCD 16 when image data is received from a scanner 20.

As shown in FIG. 3, when an instruction for activating the application is inputted by the user to a PC 10 (S101), the application is activated on the PC 10 (S102) and the scan screen 50 is displayed on the LCD 16 (S103).

After the scan screen 50 is displayed on the LCD 16, optional settings are made by the user by entering necessary values in the optional settings screen 51 (see FIG. 4A) as a part of the scan screen 50 (S104).

In the optional settings (S104), the user can properly set (1) the scan set values, (2) the target PC identification character string, (3) the PIN number, and (4) a registration instruction to a scanner 20.

On the optional settings screen 51, the user can change the scan set values (resolution, the number of colors, document size, etc.) after pressing (clicking) a “Change Setting” button 53.

The user can give a characteristic name (target PC identification character string) to the PC 10 so that the PC 10 can be easily discriminated from other target PCs, by entering a desired character string in a box 54 on the optional settings screen 51. Incidentally, when no character string is entered in the box 54, a preset target PC identification character string (initial value) is set to the PC 10.

Further, the user can set the PIN number as the authentication key of the PC 10 by entering a desired number in a box 55 on the optional settings screen 51. On an unshown screen as a part of the scan screen 50, the user can select whether or not to issue a registration instruction (requesting the registration of the PC 10) to a scanner 20.

After the above optional settings (S104) are made as needed, when a scan announcement packet transmitting instruction is inputted by the user to an unshown screen as a part of the scan screen 50 (S105), the scan announcement packet is generated by the PC 10 (S106) and is broadcasted to all the scanners 20 on the LAN (S107).

The broadcast of the scan announcement packet to all the scanners 20 on the LAN (S107) is carried out by transmitting the scan announcement packet to the broadcast address of all the scanners 20 on the LAN.

The “scan announcement packet” generated in the step S106 is a packet containing (1) information indicating that the packet is a scan announcement, (2) information capable of identifying the PC 10 on the LAN (the IP address stored in the own IP address memory 13b is used in this embodiment), and (3) the values set in the optional settings (S104).

After inputting the scan announcement packet transmitting instruction to the PC 10 (S105), the user moves to a desired scanner 20 that the user hopes to read a document image, sets a document on the scanner 20 (S108), and inputs a push scan execution instruction to the scanner 20 (S109).

After the push scan execution instruction is inputted to the scanner 20 (S109), when the scan announcement packet (transmitted repeatedly from the PC 10) is received by the scanner 20, the scanner 20 displays the PC 10 (the sender of the received scan announcement packet) on the display panel 25 in a list display, as a destination of image data (target PC) (S110). In this case, the target PC is displayed in the list, being characterized by the target PC identification character string contained in the scan announcement packet. Therefore, even when there are a plurality of target PCs, the user can easily and correctly select a desired target PC from the list.

Subsequently, the user specifies a target PC from the target PC list which has been displayed on the display panel 25 by the step S110 (S111). After specifying the target PC, if a PIN number has been contained in the scan announcement packet corresponding to the target PC, the user inputs a PIN number (S112). If the PIN number inputted by the user differs from the PIN number contained in the scan announcement packet, subsequent input of the document image reading instruction (scan instruction) by the user is prohibited. Consequently, no image data will be transmitted from the scanner 20 to the PC 10.

On the other hand, if the PIN number inputted by the user in S112 is identical with the PIN number contained in the scan announcement packet, when the scan instruction is inputted by the user (S113), the scanner 20 reads a document image (S114) and transmits image data obtained by the image reading to the IP address contained in the scan announcement packet (S115). Consequently, the image data is sent from the scanner 20 to the PC 10 (the generator (sender) of the scan announcement packet).

The PC 10 receiving the image data from the scanner 20 displays the preview screen 60 (see FIG. 4B) on the LCD 16 (S116). On the preview screen 60, a preview 61 of the document image read by the scanner 20 is displayed according to the image data. The image data is stored in the scan result memory 14b of the PC 10 when a button 62 on the preview screen 60 is pressed (clicked) by the user.

Meanwhile, the scanner 20 after reading the document image (S114) registers the target PC in itself if the registration instruction (requesting the registration of the PC 10) to the scanner 20 has been contained in the scan announcement packet (S117).

Next, the push scan executed in the image reading system of the first embodiment will be explained more specifically referring to FIGS. 5-8. FIG. 5 is a flow chart showing a (PC side) push scan process which is executed by the PC 10. The (PC side) push scan process is activated in response to the activation of the application by the user. First, the PC 10 displays the scan screen 50 on the LCD 16 (S501).

After the step S501, the PC 10 checks whether or not a cancellation instruction has been inputted by the user by performing a prescribed operation (S502). If the cancellation instruction has been inputted by the user (S502: YES), the (PC side) push scan process of FIG. 5 is ended.

If no cancellation instruction has been inputted (S502: NO), the PC 10 lets the user input the scan set values (S503), the target PC identification character string (S504) and the PIN number (S505). The inputs of S503-S505 are made by the user to the optional settings screen 51 (see FIG. 4A) as explained above.

After the step S505, the PC 10 lets the user select whether or not to issue the registration instruction (requesting the registration of the PC 10) to a scanner 20 (S506). After the step S506, the PC 10 checks whether or not the scan announcement packet transmitting instruction (instruction for transmitting the scan announcement packet) has been inputted by the user (S507).

If no scan announcement packet transmitting instruction has been inputted (S507: NO), the process returns to the step S502.

If the scan announcement packet transmitting instruction has been inputted (S507: YES), the PC 10 hides the scan screen 50 (S508), generates the scan announcement packet (S509), and executes a scan process (S510).

In the scan process (S510), steps from the transmission of the scan announcement packet generated in S509 to the reception of image data from a scanner 20 are executed. The details of the scan process (S510) will be explained later referring to FIG. 6.

After executing the scan process (S510), the PC 10 displays the preview screen 60 (see FIG. 4B), including the preview 61 of the result of the document image reading by a scanner 20 (scan result), on the LCD 16 (S511).

After the step S511, the PC 10 checks whether or not a saving instruction has been inputted by the user, that is, whether or not the user has pressed the button 52 on the preview screen 60 shown in FIG. 4B (S512). If the saving instruction has been inputted by the user (S512: YES), the PC 10 nonvolatilely stores the scan result in the scan result memory 14b (S513), hides the preview screen 60 (S514), and ends the (PC side) push scan process of FIG. 5.

On the other hand, if no saving instruction has been inputted by the user (S512: NO), the process advances to the step S514 skipping the step S513. In this case, the scan result is not saved in the PC 10.

Next, the scan process (S510) included in the above (PC side) push scan process will be explained in detail referring to FIG. 6. FIG. 6 is a flow chart showing the scan process (S510). At the start of the scan process (S510), the PC 10 broadcasts the scan announcement packet generated in S509 to all the scanners 20 on the LAN (S601). Specifically, the scan announcement packet generated in S509 is transmitted to the broadcast address of all the scanners 20 on the LAN.

After the step S601, the PC 10 waits a prescribed time period (e.g. 10 seconds) (S602) and checks whether image data has been received from a scanner 20 or not (S603). If image data has been received (S603: YES), the PC 10 processes the received image data (S605) and ends the scan process of S510.

On the other hand, if no image data has been received (S603: NO), the PC 10 checks whether or not an ending instruction has been inputted by the user by performing a prescribed operation (S604). If the ending instruction has been inputted (S604: YES), the scan process of FIG. 6 (S510) is ended. If no ending instruction has been inputted (S604: NO), the process returns to the step S601.

Next, the (scanner side) push scan process executed by the scanner 20 will be explained referring to FIG. 7. FIG. 7 is a flow chart showing the (scanner side) push scan process. The (scanner side) push scan process is activated when the push scan execution instruction is inputted by the user by performing a prescribed operation. First, the scanner 20 executes a target PC searching process for searching for a PC 10 as the destination of image data (target PC) (S701).

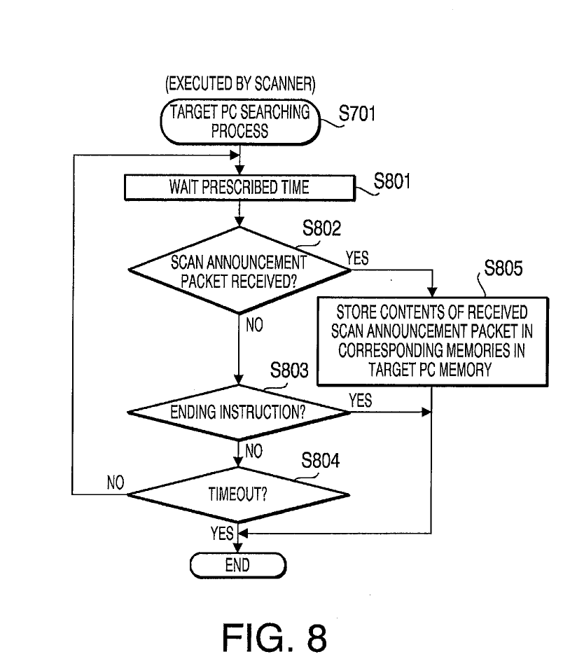

The target PC searching process (S701) will be explained here referring to FIG. 8. FIG. 8 is a flow chart showing the target PC searching process (S701). First, the scanner 20 waits a prescribed time period (e.g. 5 seconds) (S801) and checks whether the scan announcement packet has been received or not (S802).

If the scan announcement packet has been received (S802: YES), the scanner 20 stores the contents of the received scan announcement packet in corresponding memories in the target PC memory 23c (S805).

Specifically, the IP address of the target PC contained in the received scan announcement packet is stored in the IP address memory 23c1. When the scan set values are contained in the scan announcement packet, the scan set values are stored in the scan set value memory 23c2.

When the target PC identification character string is contained in the scan announcement packet, the target PC identification character string is stored in the target PC identification character string memory 23c3. When the PIN number is contained in the scan announcement packet, the PIN number is stored in the PIN number memory 23c4.

Further, when the registration instruction to the scanner 20 is contained in the scan announcement packet, the registration flag 23c5 is turned ON. On the other hand, when no registration instruction to the scanner 20 is contained in the scan announcement packet, the registration flag 23c5 is kept OFF.

Incidentally, when scan announcement packets from two or more PCs 10 are received at the same time, the contents of each of the received scan announcement packets are stored separately (in memories corresponding to each scan announcement packet) in the target PC memory 23c.

As the result of the step S805, a PC 10 as the sender of the scan announcement packet is found as a target PC by the scanner 20. After the step S805, the target PC searching process of FIG. 8 (S701) is ended.

In the step S802, if no scan announcement packet has been received (S802: NO), the scanner 20 checks whether or not an ending instruction has been inputted by the user by performing a prescribed operation (S803). If the ending instruction has been inputted (S803: YES), the target PC searching process of FIG. 8 (S701) is ended.

If no ending instruction has been inputted (S803: NO), the scanner 20 checks whether or not a timeout has occurred, that is, whether or not a prescribed time period (e.g. 30 seconds) has passed since the start of the target PC searching process (S804). If the timeout has occurred (S804: YES), the target PC searching process of FIG. 8 (S701) is ended.

On the other hand, if no timeout has occurred (S804: NO), the process returns to the step S801.

The explanation of the (scanner side) push scan process will be continued referring again to FIG. 7. After executing the target PC searching process (S701) as above, the scanner 20 checks whether or not there exists a target PC, that is, whether or not there exists a PC 10 whose information has been stored in the target PC memory 23c (S702). If there exists a target PC (S702: YES), the scanner 20 reads out each target PC identification character string which has been stored in the target PC identification character string memory 23c3 and displays a list of target PCs on the display panel 25 by use of each target PC identification character string (S703).

In the step S703, the list display is made using all the target PC identification character strings stored in the target PC identification character string memory 23c3. Thus, even when there exist two or more target PCs, each target PC can be characterized in the list by the target PC identification character string, to be discriminable from other target PCs.

Therefore, the user can select a PC 10 that is desired to be the destination of the image data (target PC) without fail, by which misdelivery of the image data read by the scanner 20 can be prevented securely.

After the step S703, the scanner 20 checks whether or not a cancellation instruction has been inputted by the user by performing a prescribed operation (S704). If the cancellation instruction has been inputted by the user (S704: YES), the (scanner side) push scan process of FIG. 7 is ended.

On the other hand, if no cancellation instruction has been inputted (S704: NO), the scanner 20 lets the user specify a target PC from the list (S705). After a target PC is specified in S705, the scanner 20 hides the target PC list which has been displayed on the display panel 25 (S706).

After the step S706, the scanner 20 checks whether or not a PIN number has been stored in the PIN number memory 23c4 corresponding to the specified target PC (S707). If a PIN number has been stored (S707: YES), the scanner 20 requests the user to input a PIN number (S708) and lets the user input the PIN number (S709).

After the step S709, the scanner 20 checks whether or not the PIN number inputted by the user in S709 is identical with the PIN number stored in the PIN number memory 23c4 corresponding to the specified target PC (S710). If identical (S710: YES), the scanner 20 lets the user input the scan instruction through the operation keys 24 (S711). In response to the scan instruction, the scanner 20 lets the scan unit 29 read a document image (S712), transmits image data obtained by the image reading to the target PC specified in S705 (S713), and advances to step S714.

In the step S712, the document image reading is executed according to the scan set values stored in the scan set value memory 23c2, that is, the scan set values inputted by the user in S503 of the (PC side) push scan process of FIG. 5 and included in the scan announcement packet. Therefore, the user does not have to set the scan set values again on the scanner side, which is convenient to the user.

Thanks to the elimination of the need of setting the scan set values again on the scanner side, the user operation to the scanner 20 is simplified. Further, part of the operation keys 24 and display panel 25 of the scanner 20 for making the scan settings can be left out, by which the costs of the scanner 20 can be reduced.

In the step S710, if the PIN number inputted by the user in S709 differs from the PIN number stored in the PIN number memory 23c4 corresponding to the specified target PC (S710: NO), the process returns to the step S703 to display the target PC list on the display panel 25 again and let the user specify a target PC from the list.

Therefore, no image data is transmitted to the specified target PC when a different PIN number (different from the PIN number (authentication key) previously associated with the target PC in S505) is inputted by the user in the step S709. As above, the user is not allowed to transmit image data to a target PC (PC 10) that has been associated with a PIN number unknown to the user, by which misdelivery of image data to an unintended PC 10 can be prevented. Further, transmission of image data to an unintended terminal device by an outsider and a resultant leak of the contents of the document can be eliminated.

In the step S707, if no PIN number has been stored in the PIN number memory 23c4 corresponding to the specified target PC (S707: NO), the process advances to the step S711 skipping the steps S708-S710, by which the image data of the document image read by the scan unit 29 is transmitted to the target PC specified in S705.

In the step S714, the scanner 20 checks whether the registration flag 23c5 corresponding to the specified target PC is ON or not. If the registration flag 23c5 is ON (S714: YES), the scanner 20 registers the specified target PC in the registered PC memory 26a (S715) and advances to step S716. In the step S715, pieces of information which have been stored in the target PC memory 23c corresponding to the target PC specified by the user in S705, excluding the registration flag 23c5, are stored in corresponding memories in the registered PC memory 26a.

On the other hand, if the registration flag 23c5 is not ON (S714: NO), the process advances to step S716 skipping the step S715.

In the step S716, the scanner 20 clears the target PC memory 23c. After the step S716, the (scanner side) push scan process of FIG. 7 is ended.

In the step S702, if there exists no target PC (S702: NO), the scanner 20 checks whether or not a target PC re-searching instruction has been inputted by the user by performing a prescribed operation (S717). If the target PC re-searching instruction has been inputted (S717: YES), the process returns to the step S701 to execute the target PC searching process again.

On the other hand, if no target PC re-searching instruction has been inputted (S717: NO), the scanner 20 checks whether or not a cancellation instruction has been inputted by the user by performing a prescribed operation (S718). If no cancellation instruction has been inputted (S718: NO), the process returns to the step S717. If the cancellation instruction has been inputted (S718: YES), the (scanner side) push scan process of FIG. 7 is ended.

Incidentally, other scanners 20 on the LAN do not generally process the scan announcement packet since the above (scanner side) push scan process is activated by the push scan execution instruction inputted by the user as mentioned above. Therefore, the number of scanners 20 for processing the scan announcement packet can be restricted to some extent.

As explained above, in the image reading system of the first embodiment, a plurality of scanners 20 connected to the LAN can identify and recognize a PC 10 on the LAN by receiving an IP address contained in the scan announcement packet broadcasted by the PC 10. Consequently, the PC 10 becomes capable of receiving image data read by each scanner 20 via the LAN (LAN cable 1) without requiring the user to make complicated settings such as previously registering the IP address of the PC 10 in each scanner 20.

Further, since any scanner 20 on the LAN can be used freely for reading a document image, the inconvenience of specifying one particular scanner 20 for each document image reading can be eliminated.

A scanner 20 receiving an IP address from a PC 10 is associated with the PC 10 in a one-to-one correspondence, by which misdelivery of image data read by the scanner 20 to a different PC 10 on the LAN can be prevented.

Since the image reading system of the first embodiment is a system according to the push scan method, various problems caused by leaving the document unattended (loss of the document, theft, illicit viewing and replacement of the document by an outsider, etc.) can be reduced securely, which is advantageous from the viewpoint of security protection.

Incidentally, the target PCs registered in the registered PC memory 26a of the scanner 20 in the step S715 of the (scanner side) push scan process (FIG. 7) become available in the image reading system of this embodiment, without the need of registering an IP address of the scanner 20 in the target PCs.

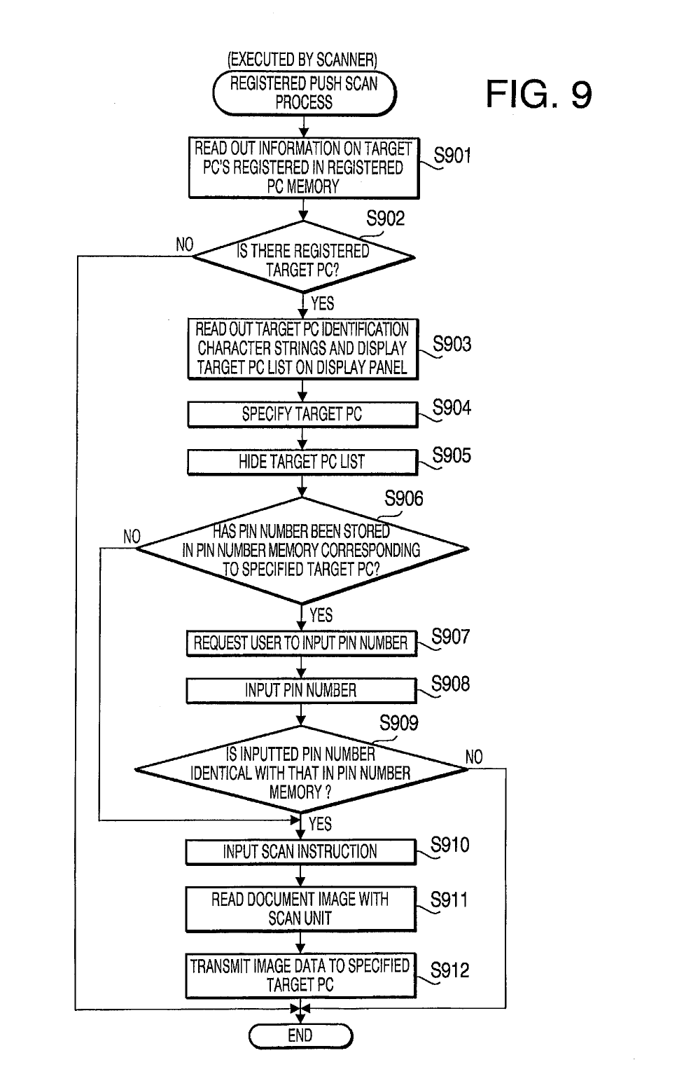

Here, a push scan (registered push scan process) which is executed by a scanner 20 to a target PC registered in the registered PC memory 26a of the scanner 20 will be explained referring to FIG. 9. FIG. 9 is a flow chart showing the registered push scan process executed by the scanner 20.

The registered push scan process is activated when a registered push scan execution instruction, requesting a push scan of document image data to a target PC registered in the scanner 20 (registered PC memory 26a), is inputted by the user by performing a prescribed operation.

As shown in FIG. 9, at the start of the registered push scan process, the scanner 20 reads out information on the target PCs registered in the registered PC memory 26a (S901) and checks whether there exists a registered target PC or not (S902).

If there exists no registered target PC (S902: NO), the registered push scan process of FIG. 9 is ended.

If there exists a registered target PC (S902: YES), the scanner 20 reads out each target PC identification character string stored in the target PC identification character string memory 26a3 and displays a list of target PCs on the display panel 25 by use of each target PC identification character string (S903).

In the step S903, the list display is made using all the target PC identification character strings stored in the target PC identification character string memory 26a3 (similarly to the step S703 of the (scanner side) push scan process of FIG. 7). Thus, even when there exist two or more registered target PCs, each registered target PC can be characterized in the list by the target PC identification character string, to be discriminable from other registered target PCs, by which misdelivery of image data can be prevented with high reliability.

After the step S903, the scanner 20 lets the user specify a target PC from the list (S904). After a target PC is specified in S904, the scanner 20 hides the target PC list which has been displayed on the display panel 25 (S905).

After the step S905, the scanner 20 checks whether or not a PIN number has been stored in the PIN number memory 26a4 corresponding to the specified target PC (S906). If a PIN number has been stored (S906: YES), the scanner 20 requests the user to input a PIN number (S907), lets the user input the PIN number (S908), and advances to step S909.

If no PIN number has been stored in the PIN number memory 26a4 (S906: NO), the process advances to step S910 skipping the steps S907 and S908.

In the step S909, the scanner 20 checks whether or not the PIN number inputted by the user in S908 is identical with the PIN number stored in the PIN number memory 26a4 corresponding to the specified target PC. If identical (S909: YES), the scanner 20 lets the user input the scan instruction (S910) and lets the scan unit 29 read a document image in response to the scan instruction (S911). In the step S911, the reading of the document image is executed according to the scan set values stored in the scan set value memory 26a2. Thereafter, the scanner 20 transmits image data obtained by the image reading to the target PC specified in S904 (S912) and ends the registered push scan process of FIG. 9.

On the other hand, if the PIN number inputted by the user in S908 differs from the PIN number stored in the PIN number memory 26a4 corresponding to the specified target PC (S909: NO), the registered push scan process of FIG. 9 is ended skipping the steps S910-S912.

Therefore, the user is not allowed to transmit image data to a target PC (PC 10) that has been associated with a PIN number unknown to the user, by which misdelivery of image data to an unintended PC 10 can be prevented. Further, transmission of image data to an unintended terminal device by an outsider and a resultant leak of the contents of the document can be eliminated.

As above, once a target PC has been registered in the scanner 20 as a result of the (scanner side) push scan process of the first embodiment, the user is allowed to quickly execute the push scan to the IP address of the registered target PC. As described above, by the (scanner side) push scan process of the first embodiment, target PCs can be registered in each scanner 20 automatically, by which the registered target PCs become available as destinations of image data (target PCs) in the image reading system, without the need of the complicated and troublesome task of registration.

### Second Embodiment

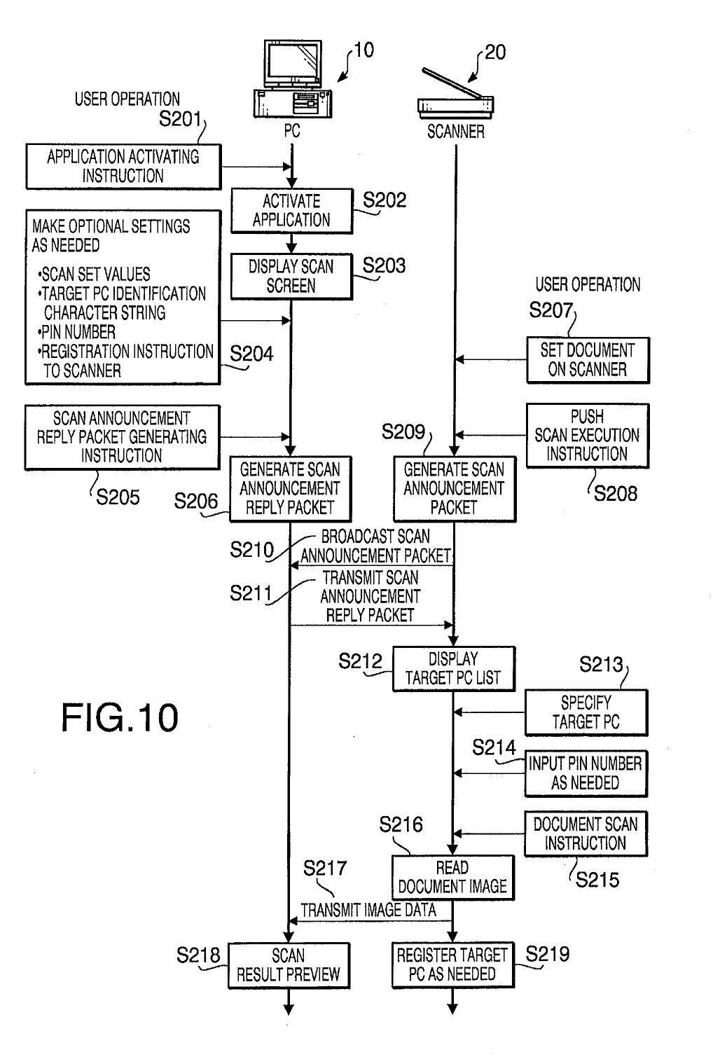

In the following, an image reading system in accordance with a second embodiment of the present invention will be described referring to FIGS. 10-13. In the above image reading system of the first embodiment, the scan announcement packet is broadcasted from a PC 10 to the broadcast address of all the scanners 20 on the LAN and image data is transmitted from a scanner 20 receiving the scan announcement packet to the PC 10 according to the push scan method.

The image reading system of the second embodiment is a system according to the push scan method similarly to the system of the first embodiment, except that a scanner 20 (not a PC 10) broadcasts a scan announcement packet containing the IP address of the scanner 20 to all the PCs 10 on the LAN.

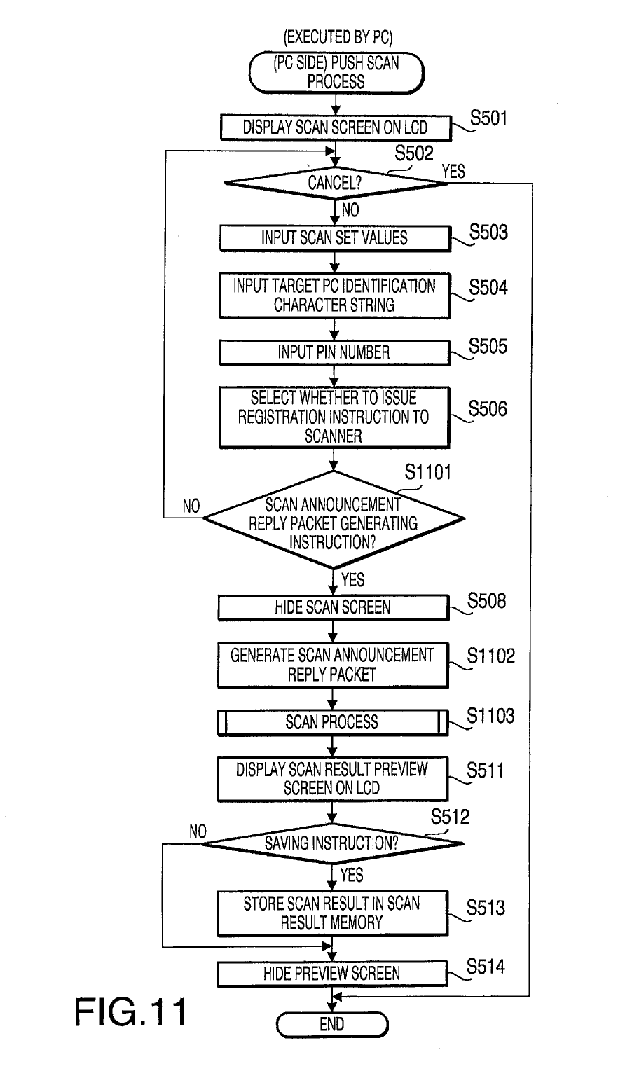

In each PC 10 in the image reading system of the second embodiment, the RAM 13 includes an announcement reply packet transmission flag (unshown) in addition to the aforementioned memories 13a-13c (see FIG. 1). The announcement reply packet transmission flag is a flag representing whether or not a scan announcement reply packet (explained later) has been transmitted to a scanner 20. The announcement reply packet transmission flag is set OFF (initial state) when a (PC side) push scan process which will be explained later (see FIG. 11) is started, and turned ON when the scan announcement reply packet is transmitted to a scanner. In the second embodiment, reference characters identical with those in the first embodiment designate elements identical or equivalent to those of the first embodiment, and thus repeated description thereof is omitted for brevity.

Here, the overall flow of a push scan which is executed in the image reading system of the second embodiment will be explained referring to FIG. 10. FIG. 10 is a conceptual diagram showing the flow of the push scan executed in the image reading system of the second embodiment.

As shown in FIG. 10, when an instruction for activating the application is inputted by the user to a PC 10 (S201), the application is activated on the PC 10 (S202) and the scan screen 50 is displayed on the LCD 16 (S203).

After the scan screen 50 is displayed on the LCD 16, optional settings are made by the user by entering necessary values in the optional settings screen 51 (see FIG. 4A) as a part of the scan screen 50 (S204). Incidentally, the contents of the optional settings and the way of inputting the set values are identical with those in the step S104 of the first embodiment.

After the optional settings (S204) are made as needed, when an instruction for generating the scan announcement reply packet (scan announcement reply packet generating instruction) is inputted by the user to an unshown screen as a part of the scan screen 50 (S205), the scan announcement reply packet is generated by the PC 10 (S206).

The “scan announcement reply packet” generated in the step S206 is a packet containing (1) information indicating that the packet is a reply to a scan announcement, (2) information capable of identifying the PC 10 on the LAN (the IP address stored in the own IP address memory 13b is used in this embodiment), and (3) the values set in the optional settings (S204).

After inputting the scan announcement reply packet generating instruction to the PC 10 (S205), the user moves to a desired scanner 20 that the user hopes to read a document image, sets a document on the scanner 20 (S207), and inputs a push scan execution instruction to the scanner 20 (S208).

In response to the push scan execution instruction, the scanner 20 generates a scan announcement packet (S209) and broadcasts the generated scan announcement packet to all the PCs 10 on the LAN (S210).

The broadcast of the scan announcement packet to all the PCs 10 on the LAN (S210) is carried out by transmitting the scan announcement packet to the broadcast address of all the PCs 10 on the LAN.

The “scan announcement packet” generated in the step S209 is a packet containing (1) information indicating that the packet is a scan announcement and (2) information capable of identifying the scanner 20 on the LAN (the IP address stored in the own IP address memory 23a is used in this embodiment).

The PC 10 that has generated the scan announcement reply packet in S206 and received the scan announcement packet (broadcasted by the scanner 20 in S210 to all the PCs 10 on the LAN) transmits the generated scan announcement reply packet to the scanner 20 as the sender of the scan announcement packet (S211). In this case, the sender of the scan announcement packet is identified by the IP address contained in the scan announcement packet.

The scanner 20 receiving the scan announcement reply packet displays the PC 10 (the sender of the received scan announcement reply packet) on the display panel 25 in a list display, as a destination of image data (target PC) (S212). In this case, the target PC is displayed in the list, being characterized by the target PC identification character string contained in the scan announcement reply packet. Therefore, even when there are a plurality of target PCs, the user can easily and correctly select a desired target PC from the list.

Subsequently, the user specifies a target PC from the target PC list which has been displayed on the display panel 25 by the step S212 (S213). After specifying the target PC, if a PIN number has been contained in the scan announcement reply packet corresponding to the target PC, the user inputs a PIN number (S214). If the PIN number inputted by the user differs from the PIN number contained in the scan announcement reply packet, subsequent input of the document image reading instruction (scan instruction) by the user is prohibited. Consequently, no image data will be transmitted from the scanner 20 to the PC 10.

On the other hand, if the PIN number inputted by the user in S214 is identical with the PIN number contained in the scan announcement reply packet, when the scan instruction is inputted by the user (S215), the scanner 20 reads a document image (S216) and transmits image data obtained by the image reading to the IP address contained in the scan announcement reply packet (S217). Consequently, the image data is sent from the scanner 20 to the PC 10 (the generator (sender) of the scan announcement reply packet).

The PC 10 receiving the image data from the scanner 20 displays the preview screen 60 (see FIG. 4B) on the LCD 16 (S218). Meanwhile, the scanner 20 after reading the document image (S216) registers the target PC in itself if a registration instruction (requesting the registration of the PC 10) to the scanner 20 has been contained in the scan announcement reply packet (S219).

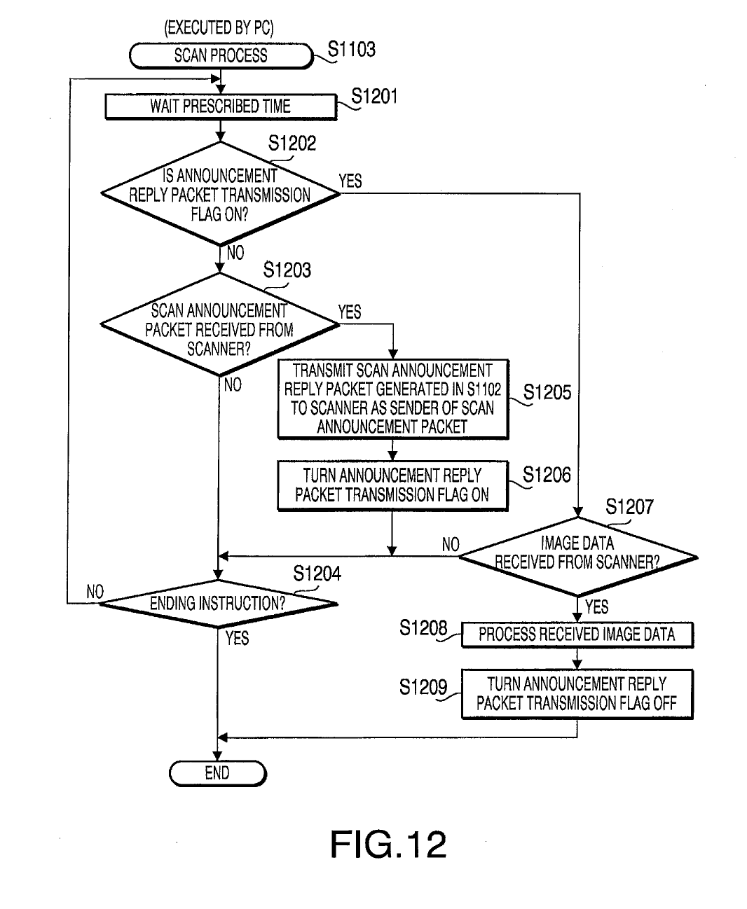

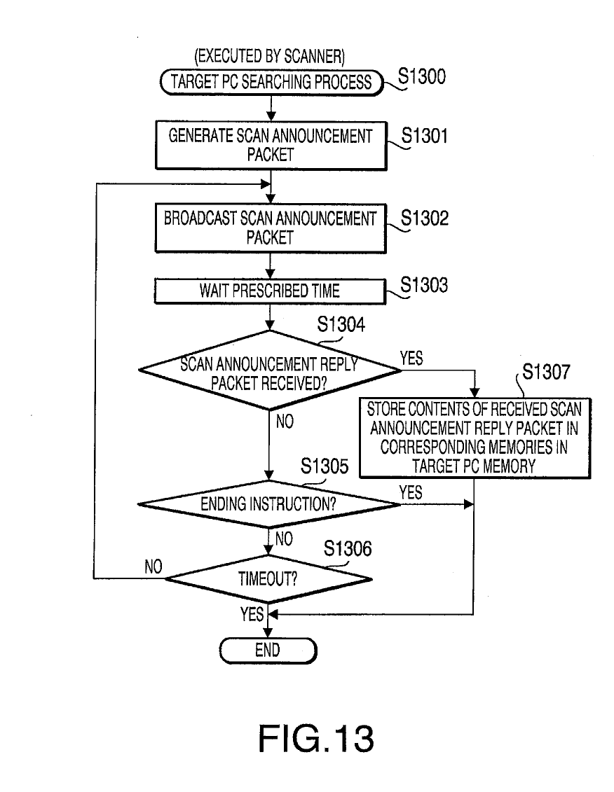

Next, the push scan executed in the image reading system of the second embodiment will be explained more specifically referring to FIGS. 11-13. FIGS. 11 and 12 (flow charts) represent a process executed by the scan application program 14a of the PC 10. FIG. 13 (flow chart) represents a process executed by a program stored in the ROM 22 of the scanner 20.

FIG. 11 is a flow chart showing a (PC side) push scan process which is executed by the PC 10 in the second embodiment. The (PC side) push scan process of the second embodiment is activated in response to the activation of the application by the user. After executing the steps S501-S506 similarly to the (PC side) push scan process of the first embodiment (FIG. 5), the PC 10 checks whether or not the scan announcement reply packet generating instruction (instruction for generating the scan announcement reply packet) has been inputted by the user (S1101).

If no scan announcement reply packet generating instruction has been inputted (S1101: NO), the process returns to the step S502.

If the scan announcement reply packet generating instruction has been inputted (S1101: YES), the PC 10 hides the scan screen 50 (S508), generates the scan announcement reply packet (S1102), and executes a scan process of the second embodiment (S1103).

In the scan process of the second embodiment (S1103), steps from the transmission of the scan announcement reply packet generated in S1102 to the reception of image data from a scanner 20 are executed. The details of the scan process (S1103) will be explained later referring to FIG. 12.

After executing the scan process (S1103), the PC 10 executes the steps S511-S514 similarly to the (PC side) push scan process of the first embodiment (FIG. 5), and ends the (PC side) push scan process of FIG. 11.

Next, the scan process (S1103) included in the above (PC side) push scan process of the second embodiment will be explained in detail referring to FIG. 12. FIG. 12 is a flow chart showing the scan process (S1103) of the second embodiment. At the start of the scan process (S1103), the PC 10 waits a prescribed time period (e.g. 5 seconds) (S1201) and thereafter checks whether the announcement reply packet transmission flag (unshown) is ON or not (S1202).

If the announcement reply packet transmission flag is OFF (S1202: NO), it means that no scan announcement reply packet has been transmitted. In this case, the PC 10 checks whether or not the scan announcement packet has been received from a scanner 20 (S1203).

If the scan announcement packet has been received (S1203: YES), the PC 10 transmits the scan announcement reply packet generated in S1102 to the scanner 20 as the sender of the received scan announcement packet (S1205). Specifically, the scan announcement reply packet generated in S1102 is transmitted to the IP address contained in the received scan announcement packet.

After the step S1205, the PC 10 turns the announcement reply packet transmission flag ON (S1206) and advances to step S1204.

On the other hand, if no scan announcement packet has been received (S1203: NO), the PC 10 checks whether or not an ending instruction has been inputted by the user by performing a prescribed operation (S1204). If the ending instruction has been inputted (S1204: YES), the scan process of FIG. 12 (S1103) is ended. If no ending instruction has been inputted (S1204: NO), the process returns to the step S1201.

In the step S1202, if the announcement reply packet transmission flag is ON (S1202: YES), it means that the PC 10 has transmitted the scan announcement reply packet to a scanner 20 and is waiting for image data transmitted from the scanner 20. In this case, the PC 10 checks whether or not image data has been received from the scanner 20 (S1207).

If image data has been received (S1207: YES), the PC 10 processes the received image data (S1208), turns the announcement reply packet transmission flag OFF (S1209), and ends the scan process (S1103) of FIG. 12.

If no image data has been received (S1207: NO), the process advances to the step S1204. Next, a target PC searching process (S1300) of the second embodiment which is executed by a scanner 20 will be explained referring to FIG. 13. FIG. 13 is a flow chart showing the target PC searching process (S1300) of the second embodiment.

The target PC searching process (S1300) is executed in the second embodiment in place of the aforementioned target PC searching process (S701) included in the (scanner side) push scan process (FIG. 7) of the first embodiment.

As shown in FIG. 13, at the start of the target PC searching process (S1300) of the second embodiment, the scanner 20 generates the scan announcement packet (S1301) and broadcasts the generated scan announcement packet to all the PCs 10 on the LAN (S1302). Specifically, the scanner 20 transmits the scan announcement packet generated in S1301 to the broadcast address of all the PCs 10 on the LAN.

After the step S1302, the scanner 20 waits a prescribed time period (e.g. 10 seconds) (S1303) and thereafter checks whether or not the scan announcement reply packet has been received (S1304).

If the scan announcement reply packet has been received (S1304: YES), the scanner 20 stores the contents of the received scan announcement reply packet in corresponding memories in the target PC memory 23c (S1307).

The storing of the contents of the scan announcement reply packet in the target PC memory 23c (S1307) is carried out similarly to the step S805 of the target PC searching process (FIG. 8) of the first embodiment. Incidentally, when scan announcement reply packets from two or more PCs 10 are received at the same time, the contents of each of the received scan announcement reply packets are stored separately (in memories corresponding to each scan announcement reply packet) in the target PC memory 23c.

As the result of the step S1307, a PC 10 as the sender of the scan announcement reply packet is found as a target PC by the scanner 20. After the step S1307, the target PC searching process of FIG. 13 (S1300) is ended.

In the step S1304, if no scan announcement reply packet has been received (S1304: NO), the scanner 20 checks whether or not an ending instruction has been inputted by the user by performing a prescribed operation (S1305). If the ending instruction has been inputted (S1305: YES), the target PC searching process of FIG. 13 (S1300) is ended.

If no ending instruction has been inputted (S1305: NO), the scanner 20 checks whether or not a timeout has occurred, that is, whether or not a prescribed time period (e.g. 30 seconds) has passed since the start of the target PC searching process (S1306). If the timeout has occurred (S1306: YES), the target PC searching process of FIG. 13 (S1300) is ended.

On the other hand, if no timeout has occurred (S1306: NO), the process returns to the step S1302.

As explained above, in the image reading system of the second embodiment, a plurality of PCs 10 connected to the LAN can identify and recognize a scanner 20 on the LAN by receiving an IP address contained in the scan announcement packet broadcasted by the scanner 20.

Meanwhile, a PC 10 receiving the IP address (contained in the scan announcement packet) from the scanner 20 as above sends its own IP address to the scanner 20 (sender of the broadcasted scan announcement packet) by transmitting the scan announcement reply packet, by which the scanner 20 can also identify and recognize the PC 10 on the LAN.

Consequently, each PC 10 can receive image data read by the scanner 20 via the LAN (LAN cable 1) without requiring the user to make complicated settings such as registering the IP address of each PC 10 in the scanner 20 or registering the IP address of the scanner 20 in each PC 10.

Further, since any PC 10 on the LAN can be used freely for receiving a document image, the inconvenience of specifying one particular PC 10 for each document image reception can be eliminated.

Since a scanner 20 and a PC 10 is associated with each other in a one-to-one correspondence, misdelivery of image data read by the scanner 20 to a different PC 10 on the LAN can be prevented.

Since the image reading system of the second embodiment is a system according to the push scan method, various problems caused by leaving the document unattended (loss of the document, theft, illicit viewing and replacement of the document by an outsider, etc.) can be reduced securely, which is advantageous from the viewpoint of security protection.

### Third Embodiment

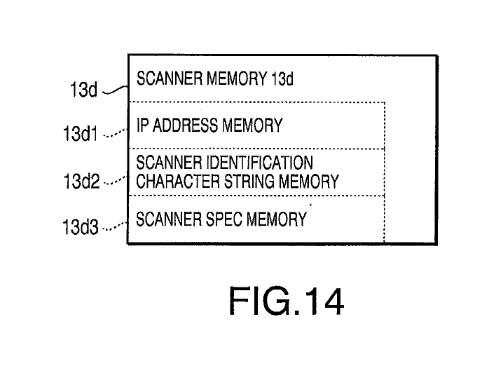

In the following, an image reading system in accordance with a third embodiment of the present invention will be described referring to FIGS. 14-19. The aforementioned image reading system of the first embodiment was a system according to the push scan method, in which image data of a document image read by a scanner 20 is sent out to a PC 10 via the LAN cable 1 in response to the document image reading instruction inputted to the scanner 20.

The image reading system of the third embodiment is a system according to the pull scan method, in which a scanner 20 reads a document image in response to a document reading instruction issued from a PC 10 and transmits image data obtained by the image reading to the PC 10. In the third embodiment, reference characters identical with those in the first embodiment designate elements identical or equivalent to those of the first embodiment, and thus repeated description thereof is omitted for brevity.

In each PC 10 in the image reading system of the third embodiment, the RAM 13 includes scanner memory 13d and an announcement reply packet reception flag (unshown) in addition to the aforementioned memories 13a-13c (see FIG. 1).

The scanner memory 13d stores information contained in a scan announcement reply packet received from a scanner 20. Here, the scanner memory 13d will be explained specifically referring to FIG. 14. FIG. 14 is a schematic diagram showing an example of memory structure of the scanner memory 13d.

As shown in FIG. 14, the scanner memory 13d includes IP address memory 13d1, scanner identification character string memory 13d2 and scanner spec memory 13d3. The IP address memory 13d1 stores an IP address of each scanner 20 as a reader (sender) of image data (hereinafter referred to as a “target scanner”).

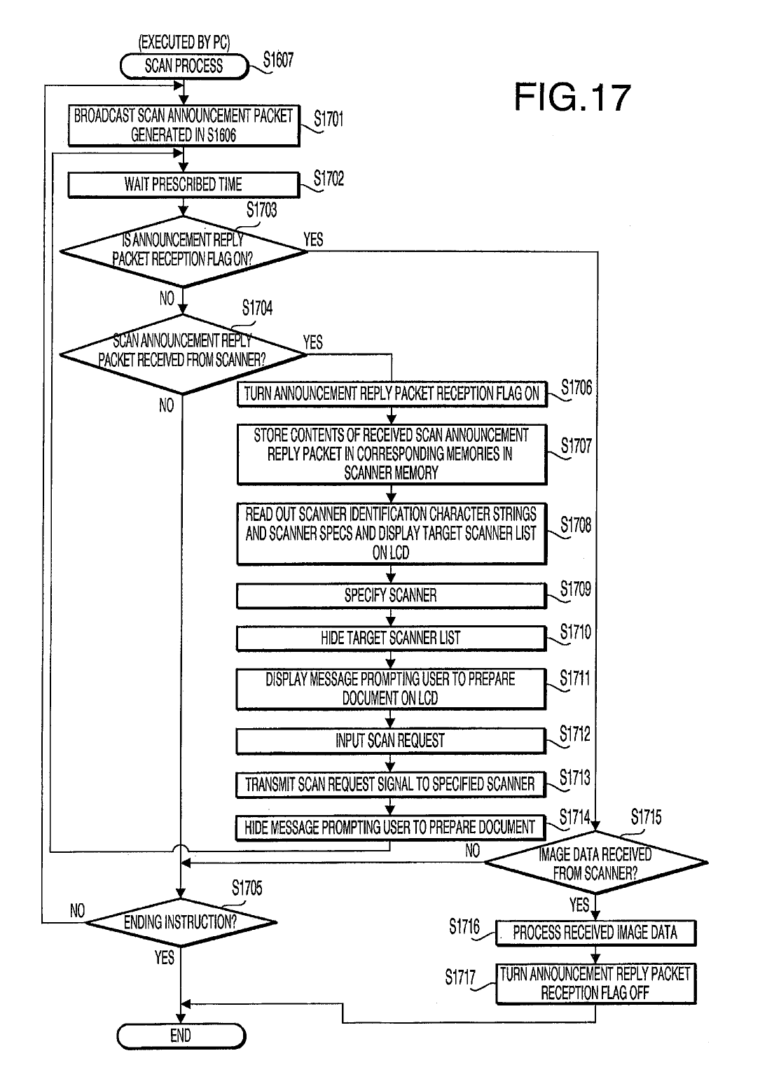

The scanner identification character string memory 13d2 stores a character string (hereinafter referred to as a “scanner identification character string”) to be used for representing each scanner 20 as a reader (sender) of image data (target scanner) on the LCD 16 in a scan process (explained later, see FIG. 17) so that the target scanner will be characterized to be discriminable from other target scanners.

The scanner spec memory 13d3 stores specifications (resolution, the number of colors, sheet size, etc.) of each target scanner (scanner 20) that can be set or employed in the document image reading (hereinafter referred to as “scanner specs”).

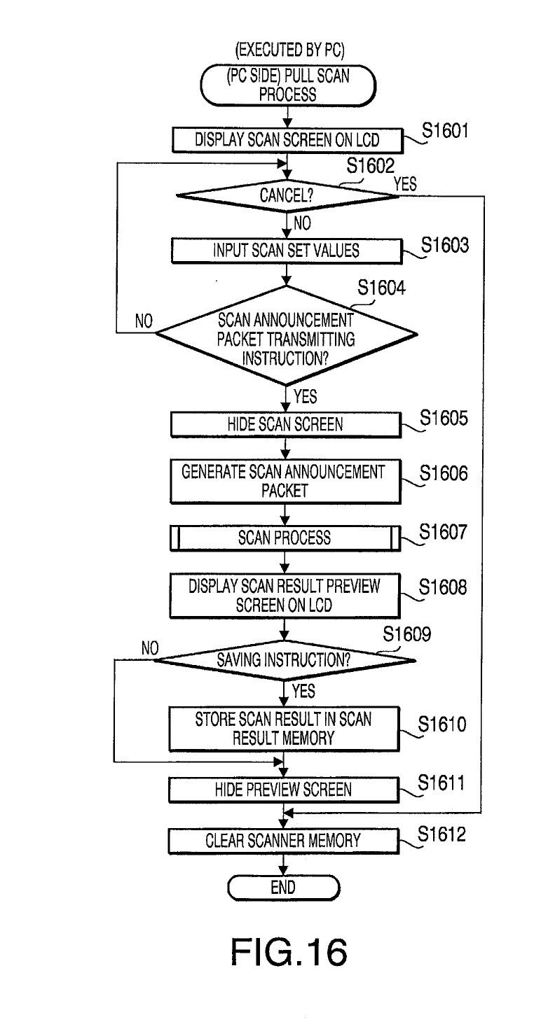

The announcement reply packet reception flag (unshown) is a flag representing whether or not a scan announcement reply packet (explained later) has been received from a scanner 20. The announcement reply packet reception flag is set OFF (initial state) when a (PC side) pull scan process which will be explained later (see FIG. 16) is started, and turned ON when the scan announcement reply packet is received from a scanner.

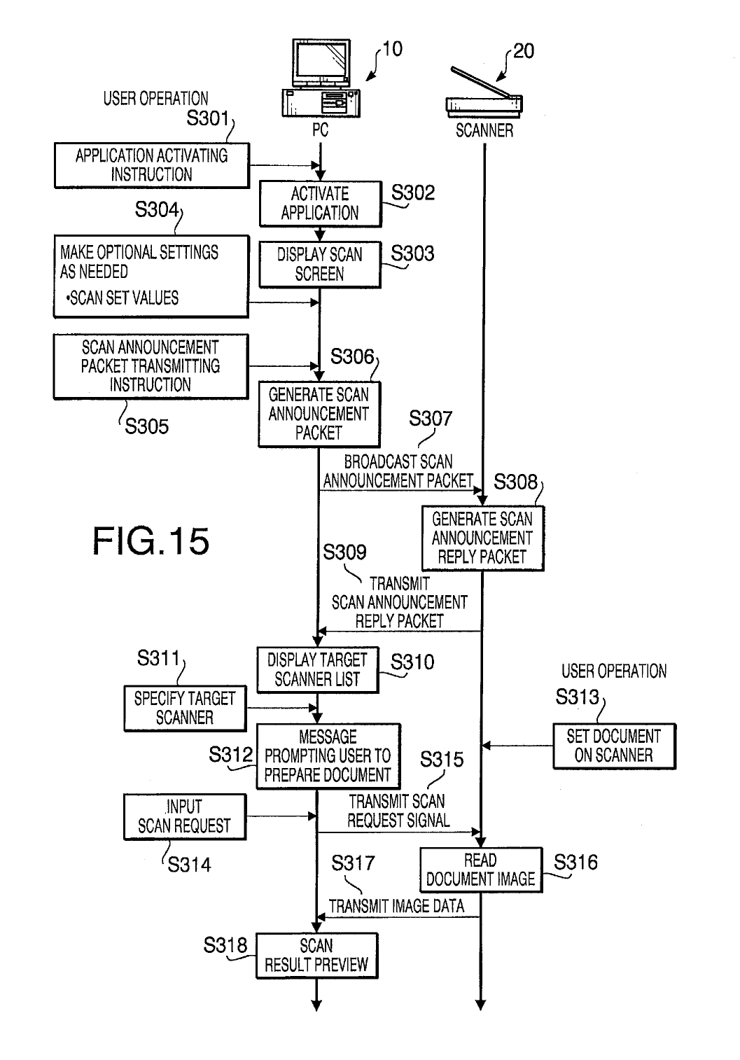

Here, the overall flow of a pull scan which is executed in the image reading system i of the third embodiment will be explained referring to FIG. 15. FIG. 15 is a conceptual diagram showing the flow of the pull scan executed in the image reading system of the third embodiment.

As shown in FIG. 15, when an instruction for activating the application is inputted by the user to a PC 10 (S301), the application is activated on the PC 10 (S302) and the scan screen 50 is displayed on the LCD 16 (S303).

After the scan screen 50 is displayed on the LCD 16, optional settings are made by the user by entering necessary values in the optional settings screen 51 (see FIG. 4A) as a part of the scan screen 50 (S304). Since the image reading system of the third embodiment is a system according to the pull scan method, the scan set values are enabled as options in the step S304. Incidentally, the way of inputting the scan set values in S304 is identical with that in S104 of the first embodiment.

After the optional settings (S304) are made as needed, when a scan announcement packet transmitting instruction is inputted by the user to an unshown screen as a part of the scan screen 50 (S305), the scan announcement packet is generated by the PC 10 (S306) and is broadcasted to all the scanners 20 on the LAN (S307).

The broadcast of the scan announcement packet to all the scanners 20 on the LAN (S307) is carried out by transmitting the scan announcement packet to the broadcast address of all the scanners 20 on the LAN.

The “scan announcement packet” generated in the step S306 is a packet containing (1) information indicating that the packet is a scan announcement, (2) information capable of identifying the PC 10 on the LAN (the IP address stored in the own IP address memory 13b is used in this embodiment), and (3) the values set in the optional settings (S304).

Each scanner 20 that has been set to a mode enabling the pull scan generates the scan announcement reply packet (S308) when the scan announcement packet transmitted from the PC 10 is received.

The “scan announcement reply packet” generated in the step S308 is a packet containing (1) information indicating that the packet is a reply to a scan announcement, (2) information capable of identifying the scanner 20 on the LAN (the IP address stored in the own IP address memory 23a is used in this embodiment), and (3) optional settings (the scanner identification character string and/or the scanner specs).

Subsequently, the scanner 20 transmits the scan announcement reply packet generated in S308 to the PC 10 as the sender of the scan announcement packet (S309). In this case, the sender of the scan announcement packet is identified by the IP address contained in the scan announcement packet.

The PC 10 (the sender of the scan announcement packet) receiving the scan announcement reply packet transmitted by the scanner 20 in S309 displays the scanner 20 (the sender of the received scan announcement reply packet) on the LCD 16 in a list display, as a reader (sender) of image data (target scanner) (S310). In this case, when the scanner identification character string is contained in the scan announcement reply packet, the target scanner is displayed in the list being characterized by the scanner identification character string, by which the user can easily and correctly select a proper target scanner from the list even when there are a plurality of target scanners.

When the scanner specs are contained in the scan announcement reply packet, possible scan settings of the target scanner are also displayed in the list at the same time, by which the user is allowed to select a proper scanner having necessary capabilities.

Subsequently, the user specifies a target scanner from the target scanner list which has been displayed on the LCD 16 by the step S310 (S311). After the target scanner is specified by the user, the PC 10 displays a message or screen on the LCD 16 to prompt the user to prepare a document (S312).

The user seeing the message or screen on the LCD 16 moves to the target scanner (scanner 20) specified in S311 and sets a document on the scanner 20 (S313). After setting the document on the scanner 20, the user returns to the PC 10 and inputs a document image reading request (hereinafter also referred to as a “scan request”) by performing a prescribed operation (S314).

In response to the scan request (S314), the PC 10 transmits a scan request signal to the target scanner (S315). In this case, the scan request signal is transmitted to a scanner 20 that is identified by the IP address contained in the scan announcement reply packet.

The scanner 20 receiving the scan request signal from the PC 10 reads a document image (S316) and transmits image data obtained by the image reading to the IP address contained in the scan announcement packet (S317). Consequently, the image data is sent from the scanner 20 to the PC 10 (the generator (sender) of the scan announcement packet).

The PC 10 receiving the image data from the scanner 20 displays the preview screen 60 (see FIG. 4B) on the LCD 16 (S318). On the preview screen 60, a preview 61 of the document image read by the scanner 20 is displayed according to the image data. The image data is stored in the scan result memory 14b of the PC 10 when the button 62 on the preview screen 60 is pressed (clicked) by the user.

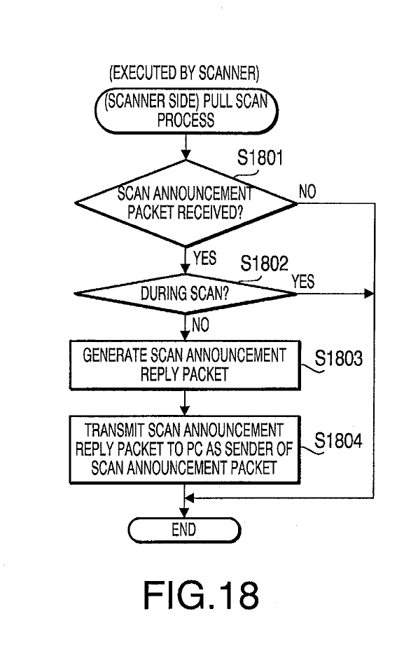

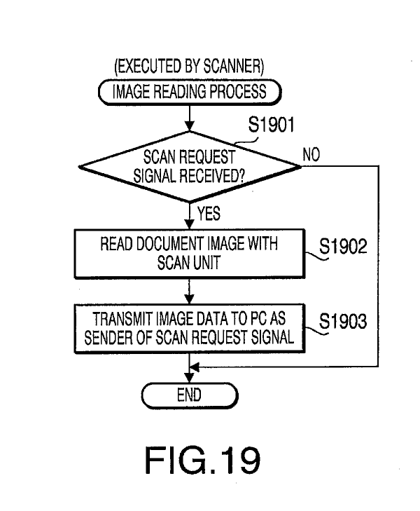

Next, the pull scan executed in the image reading system of the third embodiment will be explained more specifically referring to FIGS. 16-19. FIGS. 16 and 17 (flow charts) represent a process executed by the scan application program 14a of the PC 10. FIGS. 18 and 19 (flow charts) represent processes executed by programs stored in the ROM 22 of the scanner 20.

FIG. 16 is a flow chart showing a (PC side) pull scan process which is executed by the PC 10. The (PC side) pull scan process is activated in response to the activation of the application by the user. First, the PC 10 displays the scan screen 50 on the LCD 16 (S1601).

After the step S1601, the PC 10 checks whether or not a cancellation instruction has been inputted by the user by performing a prescribed operation (S1602). If the cancellation instruction has been inputted by the user (S1602: YES), the (PC side) pull scan process of FIG. 16 is ended.

If no cancellation instruction has been inputted (S1602: NO), the PC 10 lets the user input the scan set values to the optional settings screen 51 (see FIG. 4A) (S1603) and checks whether or not the scan announcement packet transmitting instruction (instruction for transmitting the scan announcement packet) has been inputted by the user (S1604).

If no scan announcement packet transmitting instruction has been inputted (S1604: NO), the process returns to the step S1602.

On the other hand, if the scan announcement packet transmitting instruction has been inputted (S1604: YES), the PC 10 hides the scan screen 50 (S1605), generates the scan announcement packet (S1606), and executes a scan process (S1607).

In the scan process (S1607), steps from the transmission of the scan announcement packet generated in S1606 to the reception of image data from a scanner 20 are executed. The details of the scan process (S1607) will be explained later referring to FIG. 17.

After executing the scan process (S1607), the PC 10 displays the preview screen 60 (see FIG. 4B), including the preview 61 of the result of the document image reading by a scanner 20 (scan result), on the LCD 16 (S1608).

After the step S1608, the PC 10 checks whether or not a saving instruction has been inputted by the user, that is, whether or not the user has pressed the button 52 on the preview screen 60 shown in FIG. 4B (S1609). If the saving instruction has been inputted by the user (S1609: YES), the PC 10 nonvolatilely stores the scan result in the scan result memory 14b (S1610), hides the preview screen 60 (S1611), clears the scanner memory 13d (S1612), and ends the (PC side) pull scan process of FIG. 16.

On the other hand, if no saving instruction has been inputted by the user (S1609: NO), the process advances to the step S1611 skipping the step S1610. In this case, the scan result is not saved in the PC 10.

Next, the scan process (S1607) included in the above (PC side) pull scan process will be explained in detail referring to FIG. 17. FIG. 17 is a flow chart showing the scan process (S1607). At the start of the scan process (S1607), the PC 10 broadcasts the scan announcement packet generated in S1606 to all the scanners 20 on the LAN (S1701). Specifically, the scan announcement packet generated in S1606 is transmitted to the broadcast address of all the scanners 20 on the LAN.

After the step S1701, the PC 10 waits a prescribed time period (e.g. 5 seconds) (S1702) and checks whether the announcement reply packet reception flag (unshown) is ON or not (S1703). If the announcement reply packet reception flag is OFF, that is, if no reception of the scan announcement reply packet has been recorded in the announcement reply packet reception flag (S1703: NO), the PC 10 checks whether or not the scan announcement reply packet has been received from a scanner 20 (S1704).

If the scan announcement reply packet has been received (S1704: YES), the PC 10 turns the announcement reply packet reception flag ON (S1706) and stores the contents of the received scan announcement reply packet in corresponding memories in the scanner memory 13d (S1707).

Specifically, the IP address of the target scanner contained in the received scan announcement reply packet is stored in the IP address memory 13d1. When the scanner identification character string is contained in the scan announcement reply packet, the scanner identification character string is stored in the scanner identification character string memory 13d2. When the scanner specs are contained in the scan announcement reply packet, the scanner specs are stored in the scanner spec memory 13d3.

Incidentally, when scan announcement reply packets from two or more scanners 20 are received at the same time, the contents of each of the received scan announcement reply packets are stored separately (in memories corresponding to each scan announcement reply packet) in the scanner memory 13d.

After the step S1707, the PC 10 reads out each scanner identification character string stored in the scanner identification character string memory 13d2 and the scanner specs stored in the scanner spec memory 13d3 and displays a list of target scanners on the LCD 16 by use of each scanner identification character string and the scanner specs (S1708).

In the step S1708, the list display is made using all the scanner identification character strings stored in the scanner identification character string memory 13d2. Thus, even when there exist two or more target scanners, each target scanner can be characterized in the list by the scanner identification character string, to be discriminable from other target scanners.

Therefore, the user can select a scanner 20 that is desired to be the reader of image data (target scanner) without fail, by which misdelivery of image data from an unintended scanner 20 can be prevented securely.

Further, all the scanner specs of all the target scanners stored in the scanner spec memory 13d3 are displayed in the list in the step S1708, by which the user is allowed to select a proper scanner having necessary capabilities even when the user has not grasped the specs of available scanners.

After the step S1708, the PC 10 lets the user specify a target scanner from the list (S1709). After a target scanner is specified in S1709, the PC 10 hides the target scanner list which has been displayed on the LCD 16 (S1710).

After the step S1710, the PC 10 displays a message or screen on the LCD 16 to prompt the user to prepare a document (S1711). The user seeing the message or screen on the LCD 16 moves to the target scanner (scanner 20) specified in S1709 and sets a document on the scanner 20.

After the step S1711, the PC 10 lets the user (who has returned to the PC 10 after setting the document on the scanner 20) input the scan request (S1712). In response to the scan request by the user, the PC 10 transmits the scan request signal to the target scanner (scanner 20) specified in S1709 (S1713), hides the message or screen prompting the user to prepare the document (S1714), and returns to the step S1702.

In the step S1713, the target scanner as the destination of the scan request signal has already been identified by the IP address stored in the corresponding IP address memory 13d1 in the scanner memory 13d, and thus the scan request signal is transmitted to the IP address.

In the step S1704, if no scan announcement reply packet has been received (S1704: NO), the PC 10 checks whether or not an ending instruction has been inputted by the user by performing a prescribed operation (S1705). If the ending instruction has been inputted (S1705: YES), the scan process of FIG. 17 (S1607) is ended. If no ending instruction has been inputted (S1705: NO), the process returns to the step S1701.

In the step S1703, if the announcement reply packet reception flag is ON (S1703: YES), it means that the PC 10 has already received the scan announcement reply packet from a scanner 20 and is waiting for image data transmitted from the scanner 20. In this case, the PC 10 checks whether or not image data has been received from the scanner 20 (S1715).

If image data has been received (S1715: YES), the PC 10 processes the received image data (S1716), turns the announcement reply packet reception flag OFF (S1717), and ends the scan process (S1103) of FIG. 17.

If no image data has been received (S1715: NO), the process advances to the step S1705. Next, a (scanner side) pull scan process which is executed by a scanner 20 will be explained referring to FIG. 18. FIG. 18 is a flow chart showing the (scanner side) pull scan process. The (scanner side) pull scan process is activated at prescribed time intervals (e.g. approximately 5 seconds) after a pull scan execution instruction is inputted by the user by performing a prescribed operation. In the (scanner side) pull scan process, the scanner 20 transmits the scan announcement reply packet in response to the scan announcement packet transmitted from a PC 10.

As shown in FIG. 18, at the start of the (scanner side) pull scan process, the scanner 20 checks whether or not the scan announcement packet has been received (S1801). If the scan announcement packet has been received (S1801: YES), the scanner 20 checks whether the scanner 20 itself is during a scan (document image reading) or not (S1802).

If not during a scan (S1802: NO), the scanner 20 generates the scan announcement reply packet (S1803) and transmits the generated scan announcement reply packet to a PC 10 as the sender of the received scan announcement packet (S1804). Specifically, the scan announcement reply packet generated in S1803 is transmitted to the IP address contained in the received scan announcement packet.

Next, an image reading process which is executed by a scanner 20 will be explained referring to FIG. 19. FIG. 19 is a flow chart showing the image reading process. The image reading process is activated at prescribed time intervals (e.g. approximately 5 seconds) after the pull scan execution instruction is inputted by the user by performing a prescribed operation. In the image reading process, the scanner 20 lets the scan unit 29 read a document image in response to the scan request signal transmitted from a PC 10.

As shown in FIG. 19, at the start of the image reading process, the scanner 20 checks whether or not the scan request signal has been received from a PC 10 (S1901). If the scan request signal has been received (S1901: YES), the scanner 20 lets the scan unit 29 read a document image (S1902). In the step S1902, the document image reading is executed according to the scan set values stored in the scan set value memory 23c2. Thereafter, the scanner 20 transmits image data obtained by the image reading to the PC 10 as the sender of the scan announcement packet and the scan request signal (S1903), and ends the image reading process of FIG. 19.

If no scan request signal has been received (S1901: NO), the scanner 20 ends the image reading process of FIG. 19 skipping the steps S1902 and S1903.

As explained above, in the image reading system of the third embodiment, the PC 10 can identify and recognize each scanner 20 available on the LAN by receiving an IP address contained in the scan announcement reply packet transmitted by the scanner 20 in reply to the scan announcement packet broadcasted by the PC 10.

In this case, scanners 20 available on the LAN are displayed in a list. The user referring to the list can recognize the scanners 20 available on the LAN and select a desired scanner 20 from the list.

Further, since any scanner 20 available on the LAN (not during a scan) can be used freely for reading a document image, the inconvenience of specifying one particular scanner 20 for each document image reading can be eliminated.

A scanner 20 receiving an IP address from a PC 10 is associated with the PC 10 in a one-to-one correspondence, by which misdelivery of image data read by the scanner 20 to a different PC 10 on the LAN can be prevented.

Since the image reading system of the third embodiment is a system according to the pull scan method, part of the operation keys 24 and the display panel 25 of the scanner 20 for inputting the image reading instruction to the scanner 20 can be left out, by which the costs of the scanner 20 can be reduced.

### Fourth Embodiment

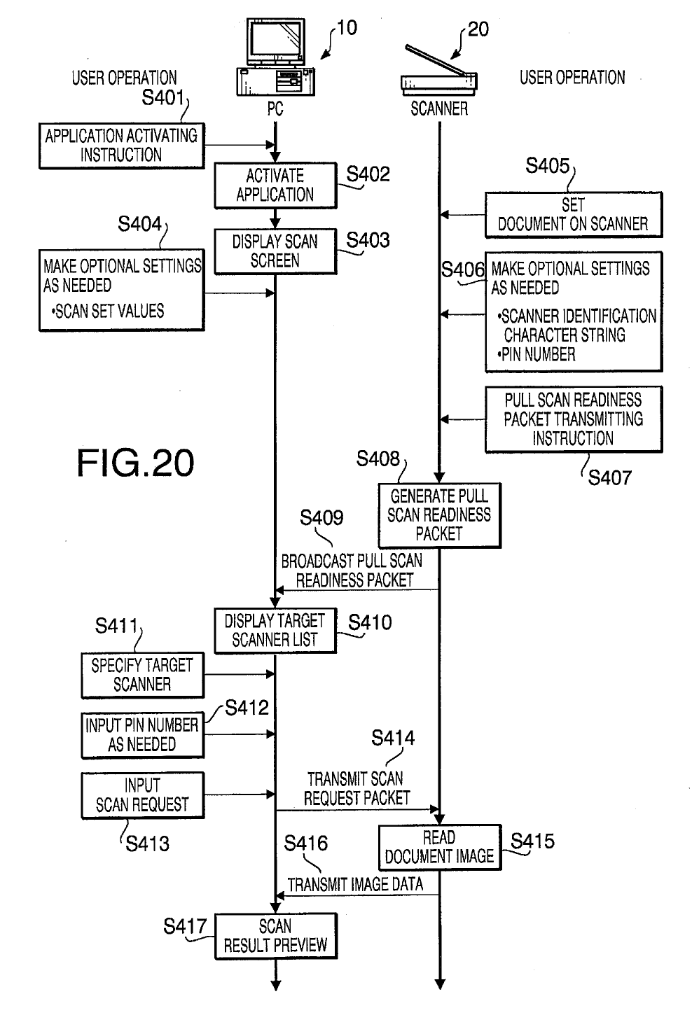

In the following, an image reading system in accordance with a fourth embodiment of the present invention will be described referring to FIGS. 20-22. In the above image reading system of the third embodiment, the scan announcement packet is broadcasted by a PC 10 to the broadcast address of all the scanners 20 on the LAN, and image data is transmitted from a scanner 20 receiving the scan announcement packet to the PC 10 according to the pull scan method.

The image reading system of the fourth embodiment is a system according to the pull scan method similarly to the image reading system of the third embodiment. In the fourth embodiment, a “pull scan readiness packet” containing the IP address of a scanner 20 (being ready for the pull scan) is broadcasted from the scanner 20 to all the PCs 10 on the LAN. In the fourth embodiment, reference characters identical with those in the first through third embodiments designate elements identical or equivalent to those of the embodiments, and thus repeated description thereof is omitted for brevity.

In each PC 10 in the image reading system of the fourth embodiment, the RAM 13 includes scanner memory 13d and a readiness packet reception flag (unshown) in addition to the aforementioned memories 13a-13c (see FIG. 1).

The scanner memory 13d in the fourth embodiment includes PIN number memory 13d4 in addition to the IP address memory 13d1, the scanner identification character string memory 13d2 and the scanner spec memory 13d3. The PIN number memory 13d4 stores a PIN number regarding a scanner 20.

The readiness packet reception flag (unshown) is a flag representing whether or not the pull scan readiness packet (explained later) has been received from a scanner 20. The readiness packet reception flag is set OFF (initial state) when the (PC side) pull scan process (see FIG. 16) is started, and turned ON when the pull scan readiness packet is received from a scanner 20.

Here, the overall flow of a pull scan which is executed in the image reading system of the fourth embodiment will be explained referring to FIG. 20. FIG. 20 is a conceptual diagram showing the flow of the pull scan executed in the image reading system of the fourth embodiment.

As shown in FIG. 20, when an instruction for activating the application is inputted by the user to a PC 10 (S401), the application is activated on the PC 10 (S402) and the scan screen 50 is displayed on the LCD 16 (S403).

After the scan screen 50 is displayed on the LCD 16, optional settings are made by the user by entering necessary values in the optional settings screen 51 (see FIG. 4A) as a part of the scan screen 50 (S404). Since the image reading system of the fourth embodiment is a system according to the pull scan method, the scan set values are enabled as options in the step S404. The way of inputting the scan set values in S404 is identical with that in S104 of the first embodiment.

After making the optional settings (S404) as needed, the user moves to a desired scanner 20 and sets a document on the scanner 20 (S405). After setting the document on the scanner 20, the user further makes optional settings as needed by properly inputting (1) the scanner identification character string and (2) the PIN number (S406).

After the optional settings (S406) are made as needed, when a pull scan readiness packet transmitting instruction is inputted by the user (S407), the pull scan readiness packet is generated by the scanner 20 (S408) and is broadcasted to all the PCs 10 on the LAN (S409).

The broadcast of the pull scan readiness packet to all the PCs 10 on the LAN (S409) is carried out by transmitting the pull scan readiness packet to the broadcast address of all the PCs 10 on the LAN.

The “pull scan readiness packet” generated in the step S408 is a packet containing (1) information indicating that the scanner 20 is in a state (mode) ready (waiting) for a pull scan, (2) information capable of identifying the scanner 20 on the LAN (the IP address stored in the own IP address memory 23a is used in this embodiment), and (3) the values set in the optional settings (S406).

The PC 10 receiving the pull scan readiness packet from the scanner 20 displays the scanner 20 (the sender of the received pull scan readiness packet) on the LCD 16 in a list display, as a reader (sender) of image data (target scanner) (S410). In this case, when the scanner identification character string is contained in the pull scan readiness packet, the target scanner is displayed in the list being characterized by the scanner identification character string, by which the user can easily and correctly select a proper target scanner from the list even when there are a plurality of target scanners.

Subsequently, the user specifies a target scanner from the target scanner list which has been displayed on the LCD 16 by the step S410 (S411). After specifying the target PC, if a PIN number has been contained in the pull scan readiness packet corresponding to the specified target scanner, the user inputs a PIN number (S412). If the PIN number inputted by the user differs from the PIN number contained in the pull scan readiness packet, subsequent input of a scan request by the user is prohibited. Consequently, no document image is read by the scanner 20 or transmitted to the PC 10.

On the other hand, if the PIN number inputted by the user in S412 is identical with the PIN number contained in the pull scan readiness packet, the user inputs the scan request by performing a prescribed operation (S413).

When the scan request is inputted by the user (S413), the PC 10 transmits a scan request packet to the target scanner (S414). The “scan request packet” is a packet containing (1) a scan request signal and (2) information capable of identifying the PC 10 on the LAN (the IP address stored in the own IP address memory 13b is used in this embodiment). In the step S414, the scan request packet is transmitted to a scanner 20 that is identified by the IP address contained in the pull scan readiness packet.

The scanner 20 receiving the scan request packet from the PC 10 reads a document image (S415) and transmits image data obtained by the image reading to the IP address contained in the scan request packet (S416). Consequently, the image data is sent from the scanner 20 to the PC 10 (the sender of the scan request packet).

The PC 10 receiving the image data from the scanner 20 displays the preview screen 60 (see FIG. 4B) on the LCD 16 (S417). On the preview screen 60, a preview 61 of the document image read by the scanner 20 is displayed according to the image data. The image data is stored in the scan result memory 14b of the PC 10 when the button 62 on the preview screen 60 is pressed (clicked) by the user.

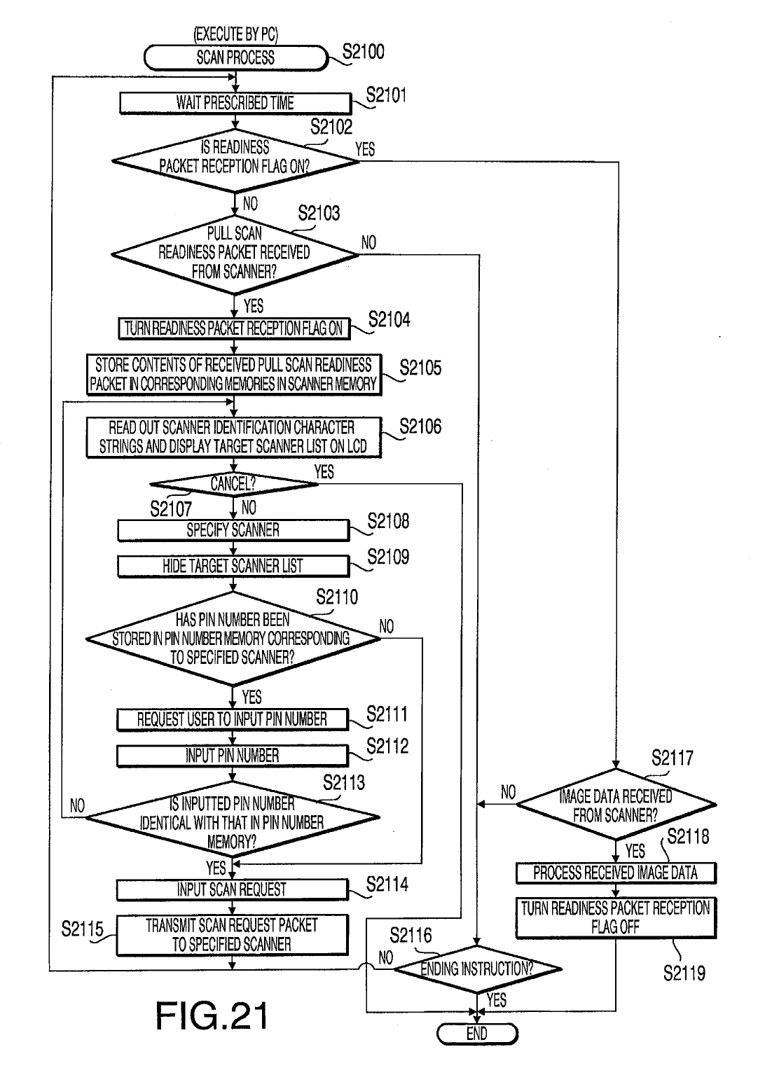

Next, a scan process (executed by a PC 10) according to the fourth embodiment will be explained referring to FIG. 21. FIG. 21 is a flow chart showing the scan process (S2100) according to the fourth embodiment.

The scan process (S2100) of the fourth embodiment is executed in place of the aforementioned scan process (S1607) included in the (PC side) pull scan process (FIG. 16) of the third embodiment.

At the start of the scan process (S2100) of the fourth embodiment, the PC 10 waits a prescribed time period (e.g. 5 seconds) (S2101) and thereafter checks whether the readiness packet reception flag (unshown) is ON or not (S2102). If the readiness packet reception flag is OFF, that is, if no reception of the pull scan readiness packet has been recorded in the readiness packet reception flag (2102: NO), the PC 10 checks whether or not the pull scan readiness packet has been received from a scanner 20 (S2103).

If the pull scan readiness packet has been received (S2103: YES), the PC 10 turns the readiness packet reception flag ON (S2104) and stores the contents of the received pull scan readiness packet in corresponding memories in the scanner memory 13d (S2105).

Specifically, in the memories 13d1-13d3 of the scanner memory 13d, the contents of the received pull scan readiness packet are stored similarly to the third embodiment. When the PIN number is contained in the received pull scan readiness packet, the PIN number is stored in the PIN number memory 13d4.

Incidentally, when pull scan readiness packets from two or more scanners 20 are received at the same time, the contents of each of the received pull scan readiness packets are stored separately (in memories corresponding to each pull scan readiness packet) in the scanner memory 13d.

After the step S2105, the PC 10 reads out each scanner identification character string stored in the scanner identification character string memory 13d2 and displays a list of target scanners on the LCD 16 by use of each scanner identification character string (S2106).

In the step S2106, the list display is made using all the scanner identification character strings stored in the scanner identification character string memory 13d2. Thus, even when there exist two or more target scanners, each target scanner can be characterized in the list by the scanner identification character string, to be discriminable from other target scanners.

Therefore, the user can select a scanner 20 that is desired to be the reader of image data (target scanner) without fail, by which misdelivery of image data from an unintended scanner 20 can be prevented securely.

After the step S2106, the PC 10 checks whether or not a cancellation instruction has been inputted by the user by performing a prescribed operation (S2107). If the cancellation instruction has been inputted by the user (S2107: YES), the scan process of FIG. 21 is ended.

If no cancellation instruction has been inputted (S2107: NO), the PC 10 lets the user specify a target scanner from the target scanner list (S2108). After the target scanner is specified (S2108), the PC 10 hides the target scanner list which has been displayed on the LCD 16 (S2109).

Subsequently, the PC 10 checks whether or not a PIN number has been stored in the PIN number memory 13d4 corresponding to the specified target scanner (S2110). If the PIN number has been stored (S2110: YES), the PC 10 requests the user to input a PIN number (S2111) and lets the user input the PIN number (S2112).

After the step S2112, the PC 10 checks whether or not the PIN number inputted by the user in S2112 is identical with the PIN number stored in the PIN number memory 13d4 corresponding to the specified target scanner (S2113). If identical (S2113: YES), the PC 10 lets the user input the scan request (S2114). In response to the scan request by the user, the PC 10 transmits the scan request packet to the target scanner (scanner 20) specified in S2108 (S2115) and thereafter returns to the step S2101.

In the step S2115, the target scanner as the destination of the scan request packet has already been identified by the IP address stored in the corresponding IP address memory 13d1 in the scanner memory 13d, and thus the scan request packet is transmitted to the IP address.

In the step S2113, if the PIN number inputted by the user in S2112 differs from the PIN number stored in the PIN number memory 13d4 corresponding to the specified target scanner (S2113: NO), the PC 10 returns to the step S2106 to display the target scanner list on the LCD 16 again and let the user specify a target scanner from the list.

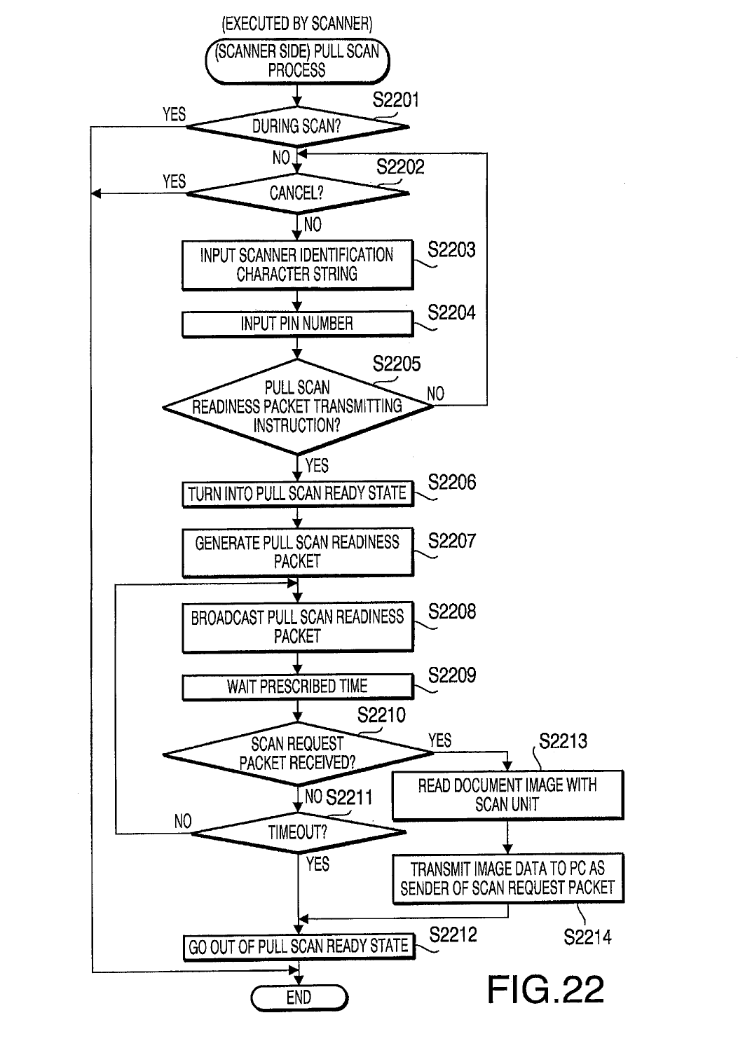

Therefore, when a different PIN number (different from a PIN number (authentication key) previously associated with the target scanner in step S2204 shown in FIG. 22) is inputted by the user in the step S2112, the image reading request (the scan request of S2114) is prohibited and consequently, no image data can be transmitted from the target scanner to the PC 10. As above, the user is not allowed to obtain image data from a target scanner (scanner 20) that has been associated with a PIN number unknown to the user, by which misdelivery (erroneous reception) of image data from an unintended scanner 20 can be prevented. Further, theft of image data from a scanner 20 by an outsider can also be prevented.

In the step S2110, if no PIN number has been stored in the PIN number memory 13d4 corresponding to the specified target scanner (S2110: NO), the process advances to the step S2114 skipping the steps S2111-S2113.

In the step S2103, if no pull scan readiness packet has been received (S2103: NO), the PC 10 checks whether or not an ending instruction has been inputted by the user by performing a prescribed operation (S2116). If the ending instruction has been inputted (S2116: YES), the scan process of FIG. 21 (S2100) is ended. If no ending instruction has been inputted (S2116: NO), the process returns to the step S2101.

In the step S2102, if the readiness packet reception flag is ON (2102: YES), it means that the PC 10 has already received the pull scan readiness packet from a scanner 20 and is waiting for image data transmitted from the scanner 20. In this case, the PC 10 checks whether or not image data has been received from the scanner 20 (S2117).

If image data has been received (S2117: YES), the PC 10 processes the received image data (S2118), turns the readiness packet reception flag OFF (S2119), and ends the scan process (S2100) of FIG. 21.

If no image data has been received (S2117: NO), the process advances to the step S2116. Next, a (scanner side) pull scan process (executed by a scanner 20) according to the fourth embodiment will be explained referring to FIG. 22. FIG. 22 is a flow chart showing the (scanner side) pull scan process according to the fourth embodiment.

The (scanner side) pull scan process of the fourth embodiment is activated when the scanner 20 is set to the mode ready (waiting) for a pull scan by a prescribed user operation. As shown in FIG. 22, the scanner 20 first checks whether the scanner 20 itself is during a scan or not (S2201). If during a scan (S2201: YES), the (scanner side) pull scan process of FIG. 22 is ended.

If not during a scan (S2201: NO), the scanner 20 checks whether or not a cancellation instruction has been inputted by the user by performing a prescribed operation (S2202). If the cancellation instruction has been inputted by the user (S2202: YES), the (scanner side) pull scan process of FIG. 22 is ended.

If no cancellation instruction has been inputted (S2202: NO), the scanner 20 lets the user input a scanner identification character string (S2203) and a PIN number (S2204).

After the step S2204, the scanner 20 checks whether or not the pull scan readiness packet transmitting instruction (instruction for transmitting the pull scan readiness packet) has been inputted by the user (S2205). If no pull scan readiness packet transmitting instruction has been inputted (S2205: NO), the process returns to the step S2202.

On the other hand, if the pull scan readiness packet transmitting instruction has been inputted (S2205: YES), the scanner 20 sets itself in a “pull scan ready state” (S2206) and generates the pull scan readiness packet (S2207).

Subsequently, the scanner 20 broadcasts the generated pull scan readiness packet to all the PCs 10 on the LAN (S2208). Specifically, the pull scan readiness packet generated in S2207 is transmitted to the broadcast address of all the PCs 10 on the LAN.

After the step S2208, the scanner 20 waits a prescribed time period (e.g. 10 seconds) (S2209) and thereafter checks whether or not the scan request packet has been received from a PC 10 (S2210).

If the scan request packet has been received (S2210: YES), the scanner 20 lets the scan unit 29 read a document image (S2213). In the step S2213, the document image reading is executed according to the scan set values stored in the scan set value memory 23c2.

Thereafter, the scanner 20 transmits image data obtained by the image reading to the IP address contained in the received scan request packet (S2214), goes out of the pull scan ready state (S2212), and ends the (scanner side) pull scan process of FIG. 22.

On the other hand, if no scan request packet has been received (S2210: NO), the scanner 20 checks whether or not a timeout has occurred, that is, whether or not a prescribed time period (e.g. 30 seconds) has passed since the start of the broadcast of the pull scan readiness packet in S2208 (S2211). If the timeout has occurred (S2211: YES), the process advances to the step S2212. If no timeout has occurred (S2211: NO), the process returns to the step S2208.

As explained above, in the image reading system of the fourth embodiment, a plurality of PCs 10 connected to the LAN can identify and recognize a scanner 20 on the LAN by receiving an IP address contained in the pull scan readiness packet broadcasted by the scanner 20. Meanwhile, a PC 10 receiving the IP address (contained in the pull scan readiness packet) from the scanner 20 as above sends its own IP address to the scanner 20 (the sender of the broadcasted pull scan readiness packet) by transmitting the scan request packet, by which the scanner 20 can also identify and recognize the PC 10 on the LAN.

Consequently, each PC 10 can receive image data read by the scanner 20 via the LAN (LAN cable 1) without requiring the user to make complicated settings such as registering the IP address of each PC 10 in the scanner 20 or registering the IP address of the scanner 20 in each PC 10.

Since a scanner 20 and a PC 10 is associated with each other in a one-to-one correspondence, misdelivery of image data read by the scanner 20 to a different PC 10 on the LAN can be prevented.

Since the image reading system of the fourth embodiment is a system according to the pull scan method, part of the operation keys 24 and the display panel 25 of the scanner 20 for inputting the image reading instruction to the scanner 20 can be left out, by which the costs of the scanner 20 can be reduced.

While a description has been given above of preferred embodiments in accordance with the present invention, the present invention is not to be restricted by the particular illustrative embodiments and a variety of modifications, design changes, etc. are possible without departing from the scope and spirit of the present invention described in the appended claims.

For example, while the scanners 20 have been taken as examples of image reading devices used in the image reading systems in the above embodiments, the scanners 20 may also be replaced with other devices (MFPs 30, etc.) having the image reading function.

While each target PC in the target PC list is characterized by the target PC identification character string to be discriminable from other target PCs in the first and second embodiments, the method of characterizing each target PC and discriminating among the target PCs is not restricted to the use of character strings; any display mode capable of characterizing each target PC to let the user visually discriminate among the target PCs can be used. For example, computer names, arbitrarily-specified icons, arbitrarily-specified colors, etc. can be used as such display modes enabling the visual discrimination among the target PCs. In this case, details of such a display mode may be specified by the user in the step S504.

Similarly, while each target scanner in the target scanner list is characterized by the scanner identification character string to be discriminable from other target scanners in the third and fourth embodiments, the method of characterizing each target scanner and discriminating among the target scanners is not restricted to the use of character strings; any display mode capable of characterizing each target scanner to let the user visually discriminate among the target scanners can be used. For example, computer names, arbitrarily-specified icons, arbitrarily-specified colors, etc. can be used as such display modes enabling the visual discrimination among the target scanners. In this case, details of such a display mode may be specified by the user in the step S2203.

While a PC 10 is registered in a scanner 20 in the first and second embodiments in the case where the user has selected the issuance of the registration instruction (requesting the registration of the PC 10 in the scanner 20) to the scanner 20 in the step S506, it is also possible to configure the embodiments so that a scanner 20 will be registered in a PC 10 when a registration instruction (requesting the registration of the scanner 20 in the PC 10) is issued on the scanner side.

By such automatic registration of the scanner 20 in the PC 10, the scanner 20 becomes available as a reader (sender) of image data in the image reading system (target scanner) without the need of the complicated and troublesome task of registration.

While the IP address is used in the above embodiments as characteristic information enabling the identification of each PC 10 or scanner 20 on the LAN, other characteristic information (node name, etc.) may also be used for the identification.

While the PIN number is used in the above embodiments as an authentication key for authenticating each target PC or target scanner, information of any type, capable of verifying that the user broadcasting the scan announcement packet or pull scan readiness packet is identical with the user using the target PC or target scanner, can be used in place of the PIN number. For example, it is possible to embed fingerprint information in the scan announcement packet or pull scan readiness packet while prompting the user of the target PC or target scanner to perform a fingerprint match.

While the target PC searching process of FIG. 13 is configured to return to the step S1302 and broadcast the scan announcement packet again when the judgment of S1306 is NO (i.e. when no scan announcement reply packet is received by the scanner 20 (S1304: NO), no ending instruction is inputted (S1305: NO) and no timeout occurs (S1306: NO)), the target PC searching process may also be configured to return to the step S1303 and wait for the reception of the scan announcement reply packet a prescribed time period (without broadcasting the scan announcement packet again) when the judgment of S1306 is NO.

It is also possible to configure the target PC searching process to return to the step S1302 (to broadcast the scan announcement packet again) a prescribed times (e.g. twice) and thereafter repeat returning to the step S1303 (to wait for the scan announcement reply packet a prescribed time period without broadcasting the scan announcement packet again) when the judgment of S1306 remains NO.

With such a configuration, even when the power of an intended PC 10 is OFF at the moment of the first broadcast of the scan announcement packet from the scanner 20 and the scanner 20 can not receive the scan announcement reply packet from the PC 10 (target PC), the scanner 20 is allowed to receive the scan announcement reply packet from the PC 10 being turned ON immediately after the first broadcast, by which the target PC on the LAN can be identified securely.

Further, since the scanner 20 stops the broadcast of the scan announcement packet after broadcasting the scan announcement packet a prescribed times, an extra traffic load on the network (LAN), caused by repeated broadcast of the scan announcement packet with no target PC (PC 10) existing on the network, can be prevented.

Similarly, while the scan process of FIG. 17 (executed by a PC 10) is configured to return to the step S1701 (to broadcast the scan announcement packet again) when the judgment of S1705 is NO (i.e. when no scan announcement reply packet is received by the PC 10 (S1704: NO) and no ending instruction is inputted (S1705: NO)), the scan process may also be configured to return to the step S1702 to wait for the scan announcement reply packet a prescribed time period without broadcasting the scan announcement packet again. With such a configuration, the target scanner (scanner 20) on the LAN can be identified securely.

It is also possible to configure the scan process to return to the step S1701 a prescribed times (e.g. twice) and thereafter repeat returning to the step S1702 when the judgment of S1705 remains NO. With such a configuration, even when the reply from the scanner 20 is delayed by some kind of trouble on the network (LAN), the target scanner (scanner 20) on the LAN can be identified securely and an extra traffic load on the network (caused by repeated broadcast of the scan announcement packet with no target scanner existing on the network) can be prevented.

What is claimed is:

1. An image reading system, comprising:
a network;
a plurality of image reading devices each of which is connected to the network and includes an image reading unit which reads an image and an image data transmitting unit which transmits image data obtained by the image reading unit to a terminal device connected to the network; and
at least one terminal device which is connected to the network and includes an image data receiving unit which receives the image data transmitted by the image data transmitting unit of the image reading device, wherein:
the terminal device includes a first notification broadcasting unit which broadcasts a notification containing characteristic information capable of identifying the terminal device on the network to the plurality of image reading devices connected to the network, and
the image data transmitting unit of one of the plurality of image reading devices reading an image transmits the image data obtained by the image reading unit to the terminal device corresponding to the characteristic information contained in the notification received from the first notification broadcasting unit.

2. The image reading system according to claim 1, wherein:
the image reading device further includes an operation unit which is operated by a user for issuing an image reading instruction to the image reading unit, and
the image data transmitting unit transmits the image data to the terminal device corresponding to the characteristic information contained in the notification received from the first notification broadcasting unit when the image reading instruction is issued through the operation unit.

3. The image reading system according to claim 1, wherein:
the notification broadcasted by the first notification broadcasting unit of the terminal device further contains set values, to be used for the image reading by the image reading unit, in addition to the characteristic information, and
the image reading device receiving the notification from the first notification broadcasting unit lets the image reading unit read an image according to the set values contained in the received notification and lets the image data transmitting unit transmit image data obtained by the image reading to the terminal device corresponding to the characteristic information contained in the received notification.

4. The image reading system according to claim 1, wherein:
the image reading device further includes an image reading device-side display unit capable of displaying information, and
the notification broadcasted by the first notification broadcasting unit of the terminal device further contains terminal device identification information, to be used for displaying the terminal device on the image reading device-side display unit while characterizing the terminal device to be discriminable from other terminal devices, in addition to the characteristic information, and
the image reading device-side display unit of the image reading device displays the terminal device thereon while characterizing the terminal device to be discriminable from other terminal devices based on the terminal device identification information contained in the notification received from the first notification broadcasting unit.

5. The image reading system according to claim 1, wherein:
the notification broadcasted by the first notification broadcasting unit of the terminal device further contains an authentication key associated with the terminal device in addition to the characteristic information, and
the image reading device further includes:
an authentication key requesting unit which requests a user to input an authentication key; and
an image reading prohibiting unit which prohibits the image reading by the image reading unit when the authentication key inputted by the user in response to the request by the authentication key requesting unit differs from the authentication key contained in the notification received from the first notification broadcasting unit.

6. The image reading system according to claim 1, wherein:
the image reading device further includes a second reply transmitting unit which replies to the notification from the first notification broadcasting unit by transmitting a reply containing characteristic information capable of identifying the image reading device on the network to the terminal device corresponding to the characteristic information contained in the received notification, and
the terminal device further includes an image reading request transmitting unit which transmits an image reading request to the image reading device corresponding to the characteristic information contained in the reply received from the second reply transmitting unit, and
the image reading device receiving the image reading request from the image reading request transmitting unit lets the image reading unit read an image and lets the image data transmitting unit transmit image data obtained by the image reading to the terminal device corresponding to the characteristic information contained in the notification received from the first notification broadcasting unit.

7. The image reading system according to claim 6, wherein:
the terminal device further includes a terminal device-side display unit capable of displaying information, and
the reply transmitted by the second reply transmitting unit of the image reading device further contains image reading device identification information, to be used for displaying the image reading device on the terminal device-side display unit while characterizing the image reading device to be discriminable from other image reading devices, in addition to the characteristic information, and
the terminal device-side display unit of the terminal device displays the image reading device thereon while characterizing the image reading device to be discriminable from other image reading devices based on the image reading device identification information contained in the reply received from the second reply transmitting unit.

8. The image reading system according to claim 6, wherein:
the reply transmitted by the second reply transmitting unit of the image reading device further contains an authentication key associated with the image reading device in addition to the characteristic information, and
the terminal device further includes:
an authentication key requesting unit which requests a user to input an authentication key; and
an image reading request prohibiting unit which prohibits the transmission of the image reading request by the image reading request transmitting unit to the image reading device associated with the authentication key when the authentication key inputted by the user in response to the request by the authentication key requesting unit differs from the authentication key contained in the reply received from the second reply transmitting unit.

9. The image reading system according to claim 1, wherein the image reading device further includes a terminal device registering unit which registers the characteristic information corresponding to the terminal device to which the image data has been transmitted by the image data transmitting unit.

10. An image reading system comprising:
a network;
at least one image reading device which is connected to the network and includes an image reading unit which reads an image and an image data transmitting unit which transmits image data obtained by the image reading unit to a terminal device connected to the network; and
a plurality of terminal devices each of which is connected to the network and includes an image data receiving unit which receives the image data transmitted by the image data transmitting unit of the image reading device, wherein:
the image reading device includes a second notification broadcasting unit which broadcasts a notification containing characteristic information capable of identifying the image reading device on the network to the plurality of terminal devices connected to the network, and
the terminal device includes a first reply transmitting unit which replies to the notification from the second notification broadcasting unit by transmitting a reply containing characteristic information capable of identifying the terminal device on the network to the image reading device corresponding to the characteristic information contained in the received notification, and
the image data transmitting unit of the image reading device receiving the reply from the first reply transmitting unit transmits the image data obtained by the image reading unit to one of the terminal devices corresponding to the characteristic information contained in the received reply.

11. The image reading system according to claim 10, wherein:
the image reading device further includes an operation unit which is operated by a user for issuing an image reading instruction to the image reading unit, and
the image data transmitting unit transmits the image data to the terminal device corresponding to the characteristic information contained in the reply received from the first reply transmitting unit when the image reading instruction is issued through the operation unit.

12. The image reading system according to claim 10, wherein:
the reply transmitted by the first reply transmitting unit of the terminal device further contains set values, to be used for the image reading by the image reading unit, in addition to the characteristic information, and
the image reading device receiving the reply from the first reply transmitting unit lets the image reading unit read an image according to the set values contained in the received reply and lets the image data transmitting unit transmit image data obtained by the image reading unit to the terminal device corresponding to the characteristic information contained in the received reply.

13. The image reading system according to claim 10, wherein:
the image reading device further includes an image reading device-side display unit capable of displaying information, and
the reply transmitted by the first reply transmitting unit of the terminal device further contains terminal device identification information, to be used for displaying the terminal device on the image reading device-side display unit while characterizing the terminal device to be discriminable from other terminal devices, in addition to the characteristic information, and
the image reading device-side display unit of the image reading device displays the terminal device thereon while characterizing the terminal device to be discriminable from other terminal devices based on the terminal device identification information contained in the reply received from the first reply transmitting unit.

14. The image reading system according to claim 10, wherein:
the reply transmitted by the first reply transmitting unit of the terminal device further contains an authentication key associated with the terminal device in addition to the characteristic information, and
the image reading device further includes:
an authentication key requesting unit which requests a user to input an authentication key; and
an image reading prohibiting unit which prohibits the image reading by the image reading unit when the authentication key inputted by the user in response to the request by the authentication key requesting unit differs from the authentication key contained in the reply received from the first reply transmitting unit.

15. The image reading system according to claim 10, wherein:
the terminal device further includes image reading request transmitting unit which transmits an image reading request to the image reading device corresponding to the characteristic information contained in the notification received from the second notification broadcasting unit, and
the image reading device receiving the image reading request from the image reading request transmitting unit lets the image reading unit read an image and lets the image data transmitting unit transmit image data obtained by the image reading unit to the terminal device corresponding to the characteristic information contained in the reply received from the first reply transmitting unit.

16. The image reading system according to claim 15, wherein:
the terminal device further includes a terminal device-side display unit capable of displaying information, and
the notification broadcasted by the second notification broadcasting unit of the image reading device further contains image reading device identification information, to be used for displaying the image reading device on the terminal device-side display unit while characterizing the image reading device to be discriminable from other image reading devices, in addition to the characteristic information, and
the terminal device-side display unit of the terminal device displays the image reading device thereon while characterizing the image reading device to be discriminable from other image reading devices based on the image reading device identification information contained in the notification received from the second notification broadcasting unit.

17. The image reading system according to claim 15, wherein:
the notification broadcasted by the second notification broadcasting unit of the image reading device further contains an authentication key associated with the image reading device in addition to the characteristic information, and
the terminal device further includes:
an authentication key requesting unit which requests a user to input an authentication key; and
an image reading request prohibiting unit which prohibits the transmission of the image reading request by the image reading request transmitting unit to the image reading device associated with the authentication key when the authentication key inputted by the user in response to the request by the authentication key requesting unit differs from the authentication key contained in the notification received from the second notification broadcasting unit.

18. The image reading system according to claim 10, wherein the image reading device further includes a terminal device registering unit which registers the characteristic information corresponding to the terminal device to which the image data has been transmitted by the image data transmitting unit.

19. The image reading system according to claim 10, wherein the terminal device further includes an image reading device registering unit which registers the characteristic information corresponding to the image reading device from which the image data has been received by the image data receiving unit.

20. A computer program product comprising computer-readable instructions to be executed by a computer, being capable of functioning as an image reading device connected to a network, the instructions causing the computer to:
read an image; and
transmit image data obtained by the image reading to a terminal device corresponding to characteristic information contained in a notification when the notification, containing the characteristic information capable of identifying the terminal device on the network and having been broadcasted by the terminal device connected to the network, is received by the image reading device.

21. The computer program product according to claim 20, wherein:
the image reading device includes an operation unit which is operated by a user for issuing an image reading instruction; and
the image data is transmitted to the terminal device corresponding to the characteristic information contained in the received notification when the image reading instruction is issued through the operation unit.

22. The computer program product according to claim 20, wherein:
the image reading device includes a display unit capable of displaying information; and
the computer-readable instructions further cause the computer to display the terminal device on the display unit while characterizing the terminal device to be discriminable from other terminal devices based on terminal device identification information when the terminal device identification information, to be used for displaying the terminal device on the display unit while characterizing the terminal device to be discriminable from other terminal devices, is received from the terminal device together with the characteristic information capable of identifying the terminal device on the network.

23. The computer program product according to claim 20, wherein the computer-readable instructions further cause the computer to:
request a user to input an authentication key when an authentication key associated with the terminal device is received from the terminal device together with the characteristic information capable of identifying the terminal device on the network; and
prohibit the image reading when the authentication key inputted by the user in response to the request for the authentication key differs from the authentication key associated with the terminal device corresponding to the received characteristic information.

24. The computer program product according to claim 20, wherein:
the image reading is executed when an image reading request is received from the terminal device corresponding to the characteristic information contained in the received notification; and
the image data obtained by the image reading is transmitted to the terminal device that transmitted the image reading request.

25. A computer program product comprising computer-readable instructions to be executed by a computer, being capable of functioning as an image reading device connected to a network, the instructions causing the computer to:
broadcast a notification containing characteristic information capable of identifying the image reading device on the network to a plurality of terminal devices connected to the network;
read an image when a reply containing characteristic information capable of identifying a terminal device on the network is received from the terminal device that received the broadcasted notification; and
transmit image data of the read image to the terminal device corresponding to the characteristic information contained in the received reply.

26. The computer program product according to claim 25, wherein:
the image reading device includes an operation unit which is operated by a user for issuing an image reading instruction; and
the image data is transmitted to the terminal device corresponding to the characteristic information contained in the received reply when the image reading instruction is issued through the operation unit.

27. The computer program product according to claim 25, wherein:
the image reading device includes a display unit capable of displaying information; and
the computer-readable instructions further cause the computer to display the terminal device on the display unit while characterizing the terminal device to be discriminable from other terminal devices based on terminal device identification information when the terminal device identification information, to be used for displaying the terminal device on the display unit while characterizing the terminal device to be discriminable from other terminal devices, is received from the terminal device together with the characteristic information capable of identifying the terminal device on the network.

28. The computer program product according to claim 25, wherein the computer-readable instructions further cause the computer to:
request a user to input an authentication key when an authentication key associated with the terminal device is received from the terminal device together with the characteristic information capable of identifying the terminal device on the network; and
prohibit the image reading when the authentication key inputted by the user in response to the request of the authentication key differs from the authentication key associated with the terminal device corresponding to the received characteristic information.

29. The computer program product according to claim 25, wherein:
the image reading is executed when an image reading request is received from the terminal device corresponding to the characteristic information contained in the received reply; and
the obtained image data is transmitted to the terminal device that transmitted the image reading request.

30. A computer program product comprising computer-readable instructions to be executed by a computer, being capable of functioning as a terminal device connected to a network, the instructions causing the computer to:
broadcast a notification containing characteristic information capable of identifying the terminal device on the network to a plurality of image reading devices connected to the network; and
receive image data, obtained by an image reading device by image reading, from the image reading device that received the broadcasted notification.

31. The computer program product according to claim 30, wherein:
the terminal device includes a display unit capable of displaying information; and
the computer-readable instructions further cause the computer to display an image reading device on the display unit while characterizing the image reading device to be discriminable from other image reading devices based on image reading device identification information when the image reading device identification information, to be used for displaying the image reading device on the display unit while characterizing the image reading device to be discriminable from other image reading devices, is received from the image reading device together with characteristic information capable of identifying the image reading device on the network.

32. The computer program product according to claim 30, wherein the computer-readable instructions further cause the computer to:
transmit an image reading request to an image reading device connected to the network;
request a user to input an authentication key when an authentication key associated with the image reading device is received from the image reading device together with characteristic information capable of identifying the image reading device on the network; and
prohibit the transmission of the image reading request to the image reading device associated with the authentication key when the authentication key inputted by the user in response to the request of the authentication key differs from the authentication key associated with the image reading device corresponding to the received characteristic information.

33. A computer program product comprising computer-readable instructions to be executed by a computer, being capable of functioning as a terminal device connected to a network, the instructions causing the computer to:
transmit a reply containing characteristic information capable of identifying the terminal device on the network to an image reading device that sent a notification when the notification containing characteristic information capable of identifying an image reading device on the network is received from the image reading device connected to the network; and
receive image data, obtained by the image reading device by image reading, from the image reading device that received the reply.

34. The computer program product according to claim 33, wherein:
the terminal device includes a display unit capable of displaying information, and
the computer-readable instructions further cause the computer to display the image reading device on the display unit while characterizing the image reading device to be discriminable from other image reading devices based on image reading device identification information when the image reading device identification information, to be used for displaying the image reading device on the display unit while characterizing the image reading device to be discriminable from other image reading devices, is received from the image reading device together with the characteristic information capable of identifying the image reading device on the network.

35. The computer program product according to claim 33, wherein the computer-readable instructions further cause the computer to:
transmit an image reading request to the image reading device connected to the network;
request a user to input an authentication key when an authentication key associated with the image reading device is received from the image reading device together with the characteristic information capable of identifying the image reading device on the network; and
prohibit the transmission of the image reading request to the image reading device associated with the authentication key when the authentication key inputted by the user in response to the request of the authentication key differs from the authentication key associated with the image reading device corresponding to the received characteristic information.

36. An image reading device connected to a network, comprising:
an image reading unit which reads an image; and
an image data transmitting unit which transmits image data obtained by the image reading unit to a terminal device corresponding to characteristic information contained in a notification when the notification, containing the characteristic information capable of identifying the terminal device on the network and having been broadcasted by the terminal device connected to the network, is received by the image reading device.

37. The image reading device according to claim 36, further comprising an operation unit which is operated by a user for issuing an image reading instruction, wherein:
the image data transmitting unit transmits the image data to the terminal device corresponding to the characteristic information contained in the received notification when the image reading instruction is issued through the operation unit.

38. The image reading device according to claim 36, further comprising:
a display unit capable of displaying information; and
a display unit which displays the terminal device on the display unit while characterizing the terminal device to be discriminable from other terminal devices based on terminal device identification information when the terminal device identification information, a to be used for displaying the terminal device on the display unit while characterizing the terminal device to be discriminable from other terminal devices, is received from the terminal device together with the characteristic information capable of identifying the terminal device on the network.

39. The image reading device according to claim 36, further comprising:
an authentication key requesting unit which requests a user to input an authentication key when an authentication key associated with the terminal device is received from the terminal device together with the characteristic information capable of identifying the terminal device on the network; and
an image reading prohibiting unit which prohibits the image reading by the image reading unit when the authentication key inputted by the user in response to the request by the authentication key requesting unit differs from the authentication key associated with the terminal device corresponding to the received characteristic information.

40. The image reading device according to claim 36, wherein:
the image reading unit executes the image reading when an image reading request is received from the terminal device corresponding to the characteristic information contained in the received notification, and
the image data transmitting unit transmits the image data obtained by the image reading unit to the terminal device that transmitted the image reading request.

41. An image reading device connected to a network, comprising:
a notification broadcasting unit which broadcasts a notification containing characteristic information capable of identifying the image reading device on the network to a plurality of terminal devices connected to the network;
an image reading unit which reads an image when a reply containing characteristic information capable of identifying a terminal device on the network is received from the terminal device that received the notification broadcasted by the notification broadcasting unit; and
an image data transmitting unit which transmits image data obtained by the image reading unit to the terminal device corresponding to the characteristic information contained in the received reply.

42. The image reading device according to claim 41, further comprising an operation unit which is operated by a user for issuing an image reading instruction, wherein:
the image data transmitting unit transmits the image data to the terminal device corresponding to the characteristic information contained in the received reply when the image reading instruction is issued through the operation unit.

43. The image reading device according to claim 41, further comprising:
a display unit capable of displaying information; and
a display unit which displays the terminal device on the display unit while characterizing the terminal device to be discriminable from other terminal devices based on terminal device identification information when the terminal device identification information, to be used for displaying the terminal device on the display unit while characterizing the terminal device to be discriminable from other terminal devices, is received from the terminal device together with the characteristic information capable of identifying the terminal device on the network.

44. The image reading device according to claim 41, further comprising:
an authentication key requesting unit which requests a user to input an authentication key when an authentication key associated with the terminal device is received from the terminal device together with the characteristic information capable of identifying the terminal device on the network; and
an image reading prohibiting unit which prohibits the image reading by the image reading unit when the authentication key inputted by the user in response to the request by the authentication key requesting unit differs from the authentication key associated with the terminal device corresponding to the received characteristic information.

45. The image reading device according to claim 41, wherein:
the image reading unit executes the image reading when an image reading request is received from the terminal device corresponding to the characteristic information contained in the received reply, and
the image data transmitting unit transmits the image data obtained by the image reading unit to the terminal device that transmitted the image reading request.
